(19) United States
(12) Patent Application Publication
(10) Pub. No.: US 2026/0247199 A1
(43) Pub. Date: Aug. 20, 2026

(54) ELECTRONIC DEVICE, COMMUNICATION METHOD, AND COMPUTER-READABLE STORAGE MEDIUM

(71) Applicant: Sony Group Corporation, Tokyo (JP)

(72) Inventors: Zhaoyu ZHANG, Beijing (CN); Xiaoxue WANG, Beijing (CN); Chen SUN, Beijing (CN)

(73) Assignee: Sony Group Corporation, Tokyo (JP)

(21) Appl. No.: 19/469,384

(22) PCT Filed: May 7, 2024
(86) PCT No.: PCT/CN2024/091357

§ 371 Date: Sep. 26, 2025

(30) Foreign Application Priority Data
May 9, 2023 (CN) 202310522703.X

(51) Int. Cl. H04W 24/10; H04W 72/0453; H04W 72/40; H04W 72/542

(52) U.S. Cl. CPC H04W 24/10; H04W 72/0453; H04W 72/40; H04W 72/542

(57) ABSTRACT

The present invention provides an electronic device, a communication method, and a computer readable storage medium. The electronic device may comprise a processing circuit. The processing circuit is configured to: obtain an index of the quality of the coordinated transmission implemented by the current coordination device, wherein the coordination device relays a part of data originating from a source device and to be transmitted to a destination device, to implement the coordinated transmission; depending on the relationship between the index and a first to third ranges which sequentially indicate the quality of transmission in descending order, generate a status report about the current coordination device; and transmit the generated status report to another electronic device.

The present application claims priority to Chinese Patent Application No. 202310522703.X, titled “ELECTRONIC DEVICE, COMMUNICATION METHOD, AND COMPUTER-READABLE STORAGE MEDIUM”, filed on May 9, 2023 with the China National Intellectual Property Administration, which is incorporated herein by reference in its entirety.

### FIELD

The present application relates to the field of wireless communication technology, and more specifically, to an electronic device, a communication method, and a computer-readable storage medium that facilitate maintaining the quality of the cooperative transmission.

### BACKGROUND

At present, wireless networks, especially mobile cellular networks, cannot provide high-speed and reliable data communication that meets user needs in some cases (for example, when a user terminal is at a cell edge or is moving at high speed, or when a user needs to upload, in real time, video services of high bitrate such as 4K/8K). Standardization organizations such as 3GPP are discussing direct communication technologies between mobile terminals such as Sidelink. Using direct communication between mobile terminals enables multiple users to perform cooperative transmission of data.

At present, there is no suitable solution for maintaining the quality of the cooperative transmission in a cooperative transmission system. Therefore, it is desired to provide a solution that facilitates maintaining the quality of the cooperative transmission.

### SUMMARY

A brief overview regarding the present disclosure is given below so as to provide a basic understanding of certain aspects of the present disclosure. However, it should be understood that this overview is not an exhaustive overview regarding the present disclosure. It is not intended to identify critical parts or important parts of the present disclosure, nor is it intended to limit the scope of the present disclosure. Its purpose is merely to present, in a simplified form, certain concepts regarding the present disclosure as a preface to more detailed description given later.

An object of at least one aspect of the present disclosure is to provide an electronic device, a (wireless) communication method, and a computer-readable storage medium, which facilitate maintaining the quality of the cooperative transmission in the cooperative transmission system.

According to a first aspect of the present disclosure, an electronic device is provided. The electronic device comprises a processing circuit configured to: obtain an index of a quality of a cooperative transmission implemented by a current cooperating device, the cooperating device relaying a part of data originating from a source device and to be transmitted to a destination device to implement the cooperative transmission; generate, depending on a relationship between the index and first to third ranges which sequentially indicate qualities of transmission from high to low, a status report about the current cooperating device; and transmit the generated status report to another electronic device.

According to a second aspect of the present disclosure, an electronic device is provided. The electronic device comprises a processing circuit configured to: receive a status report about a current cooperating device, the cooperating device relaying a part of data originating from a source device and to be transmitted to a destination device to implement a cooperative transmission; and determine, based on the received status report, an adjustment to the cooperative transmission, wherein the status report is generated depending on a relationship between an index of a quality of the cooperative transmission implemented by the current cooperating device and first to third ranges which sequentially indicate qualities of transmission from high to low.

According to a third aspect of the present disclosure, an electronic device is provided. The electronic device includes a processing circuit configured to: obtain an index of a quality of a cooperative transmission implemented by a current cooperating device, the cooperating device relaying a part of data originating from a source device and to be transmitted to a destination device to implement the cooperative transmission; determine, depending on a relationship between the index and first to third ranges which sequentially indicate qualities of transmission from high to low, an adjustment to the cooperative transmission.

According to first aspect of the present disclosure, a communication method is further provided. The method comprises: obtaining an index of a quality of a cooperative transmission implemented by a current cooperating device, the cooperating device relaying a part of data originating from a source device and to be transmitted to a destination device to implement the cooperative transmission; generating, depending on a relationship between the index and first to third ranges which sequentially indicate qualities of transmission from high to low, a status report about the current cooperating device; and transmitting the generated status report to another electronic device.

According to second aspect of the present disclosure, a communication method is further provided. The method comprises: receiving a status report about a current cooperating device, the cooperating device relaying a part of data originating from a source device and to be transmitted to a destination device to implement a cooperative transmission; and determining, based on the received status report, an adjustment to the cooperative transmission, wherein the status report is generated depending on a relationship between an index of a quality of the cooperative transmission implemented by the current cooperating device and first to third ranges which sequentially indicate qualities of transmission from high to low.

According to third aspect of the present disclosure, a communication method is further provided. The method comprises: obtaining an index of a quality of a cooperative transmission implemented by a current cooperating device, the cooperating device relaying a part of data originating from a source device and to be transmitted to a destination device to implement the cooperative transmission; determining, depending on a relationship between the index and first to third ranges which sequentially indicate qualities of transmission from high to low, an adjustment to the cooperative transmission.

According to another aspect of the present disclosure, a non-transitory computer-readable storage medium having executable instructions stored thereon is further provided. The executable instructions, when executed by a processor, cause the processor to perform the above communication methods or various functions of the above electronic devices.

According to other aspects of the present disclosure, a computer program code and a computer program product for implementing the above methods according to the present disclosure are further provided.

According to at least one aspect of embodiments of the present disclosure, by using an index of quality of cooperative transmission implemented by a current cooperating device, a status report that is generated depending on a relationship between the index and first to third ranges which indicate the quality of transmission is obtained for determining an appropriate adjustment to the cooperative transmission; or an appropriate adjustment to the cooperative transmission is directly determined depending on the above relationship, thereby facilitating maintaining the quality of the cooperative transmission.

Other aspects of embodiments of the present disclosure are given in the following description section, wherein preferred embodiments of embodiments of the present disclosure are described in detail so as to fully disclose the embodiments of the present disclosure without imposing limitations thereon.

### BRIEF DESCRIPTION OF THE DRAWINGS

The drawings described herein are only for illustrative purposes of selected embodiments, rather than all possible embodiments, and are not intended to limit the scope of the present disclosure. In the drawings:

FIGS. 1A and 1B are schematic diagrams for illustrating a cooperative transmission system to which the technology of the present disclosure may be applied;

FIG. 2 is a schematic diagram for illustrating that a rate of device-to-device (D2D) communication changes with a distance between two user equipments (UEs);

FIG. 3 is a block diagram illustrating a configuration example of an electronic device according to a first embodiment of the present disclosure;

FIG. 4 is a flowchart of example signaling interaction for illustrating acquisition of a quality-index model;

FIG. 5 is a schematic diagram illustrating an example of first to third ranges indicating quality of transmission;

FIG. 6 is a flowchart for illustrating example processing for generating a status report;

FIG. 7 is a block diagram illustrating a first configuration example of an electronic device according to a second embodiment of the present disclosure;

FIG. 8 is a block diagram illustrating a second configuration example of an electronic device according to a second embodiment of the present disclosure;

FIGS. 9A and 9B are flowcharts for illustrating example processing performed by the electronic device of FIG. 8;

FIGS. 10A and 10B are flowcharts for illustrating example signaling interaction of a cooperative transmission adjustment according to an embodiment of the present disclosure;

FIG. 11 is a block diagram illustrating a configuration example of an electronic device according to a third embodiment of the present disclosure;

FIG. 12 is a flowchart illustrating a process example of a communication method according to a first embodiment of the present disclosure;

FIG. 13 is a flowchart illustrating a process example of a communication method according to a second embodiment of the present disclosure;

FIG. 14 is a flowchart illustrating a process example of a communication method according to a third embodiment of the present disclosure;

FIG. 15 is a block diagram illustrating a first example of a schematic configuration of a server to which the technology of the present disclosure may be applied;

FIG. 16 is a block diagram illustrating a first example of a schematic configuration of an eNB to which the technology of the present disclosure may be applied;

FIG. 17 is a block diagram illustrating a second example of a schematic configuration of an eNB to which the technology of the present disclosure may be applied;

FIG. 18 is a block diagram illustrating an example of a schematic configuration of a smart phone to which the technology of the present disclosure may be applied;

FIG. 19 is a block diagram illustrating an example of a schematic configuration of a car navigation device to which the technology of the present disclosure may be applied.

Although the present disclosure may be susceptible to various modifications and alternative forms, specific embodiments thereof have been illustrated by way of examples in the drawings and have been described in detail herein. However, it should be understood that the description of specific embodiments herein is not intended to limit the present disclosure to the particular forms disclosed, but rather to cover all modifications, equivalents, and alternatives falling within the spirit and scope of the present disclosure. It should be noted that same or similar reference numerals are used throughout the drawings to refer to the same or like parts.

### DETAILED DESCRIPTION OF EMBODIMENTS

The embodiments of the present disclosure will be described completely in conjunction with the drawings. The following description is only exemplary, and is not intended to limit the present disclosure, and applications or usages thereof.

Exemplary embodiments are provided so that the present disclosure will be thorough and complete, and will fully convey the scope of the present disclosure to those skilled in the art. Numerous specific details, such as examples of specific components, devices, and methods, are described to provide a detailed understanding of the embodiments of the present disclosure. It is apparent for those skilled in the art that the exemplary embodiments may be implemented in many different forms without specific details, and should not be construed to limit the scope of the present disclosure. In some exemplary embodiments, well-known processes, well-known structures, and well-known technologies are not described in detail.

The descriptions are provided in the following order:
1. Overview
2. Configuration examples of an electronic device according to a first embodiment
   2.1 Configuration examples
   2.2 Modification examples
3. Configuration examples of an electronic device according to a second embodiment
   3.1 Configuration examples
   3.2 Example signaling interactions
   3.3 Modification examples
4. Configuration examples of an electronic device according to a third embodiment
5. Method embodiments
6. Application examples

### 1. Overview

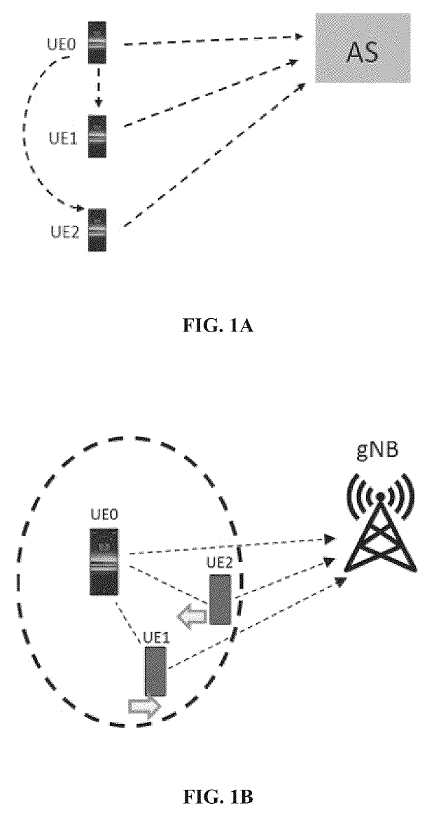

FIGS. 1A and 1B illustrate schematic diagrams of a cooperative transmission system to which the technology of the present disclosure may be applied. As illustrated in the figures, the cooperative transmission system includes a source device UE0, at least one cooperating device UEi (an example of i=1, 2 is illustrated in the figures, but the present disclosure is not limited thereto, and i may be a natural number greater than or equal to 1), and a destination device AS or gNB. The source device UE0 transmits at least a part of data to be transmitted to the destination device to one or more cooperating devices UEi for relaying, and transmits it to the destination device AS or gNB via the relay of the cooperating device UEi. The destination device may integrate the received data, or forward it to another device for integration, and the like.

In an example, the source device UE0 may split transmission data, a part of which is transmitted by UE0 and other parts are transmitted by at least one cooperating UEi. In this case, the cooperative transmission may also be referred to as aggregated transmission, and the source device may also be referred to as an aggregation-initiating UE. In another example, the source device UE0 may transmit the transmission data to the destination device only via the relay of one or more cooperating UEi without transmitting data to the destination device directly by itself. The present disclosure is applicable to the above two example cases, which will not be repeated here.

The cooperative transmission system may have different application scenarios, for example but not limited to an application-layer (APP layer) illustrated in FIG. 1A and a radio access network (RAN) side illustrated in FIG. 1B. In the example of the APP layer in FIG. 1A, the destination device may be, for example, an aggregation server AS that implements an aggregation function (here, although referred to as a “server”, the AS may be any device that implements an aggregation function, including a terminal device and the like), or a device that forwards data originating from the source UE0 to the aggregation server. In the example of the RAN side in FIG. 1B, the destination device may be, for example, a network-side device such as a base station gNB, which may implement an aggregation function by itself or forward data originating from the source UE0 to another device that implements an aggregation function. Optionally, in the example of FIG. 1B, for example in a case where direct communication is performed between the source UE0 and the cooperating UEi via a sidelink (Sidelink), a network-side device such as a base station gNB may allocate communication resources for the direct communication.

In the cooperative transmission system, factors such as mobility of users (UE0 and UEi) affect the quality of transmission of the system and thus its robustness.

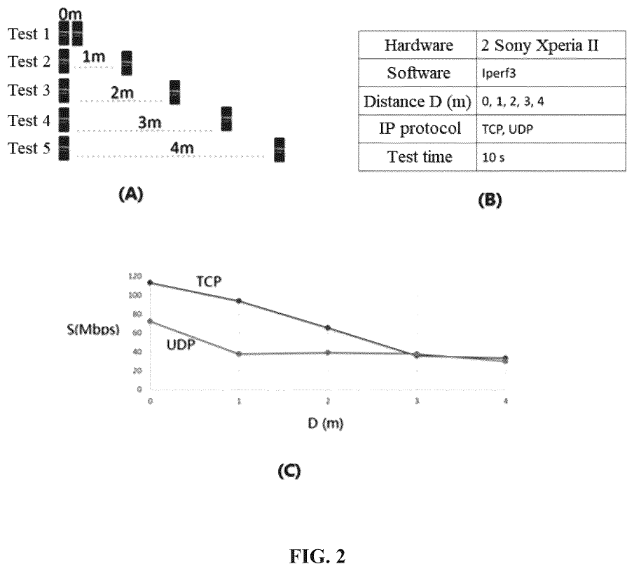

For example, when the cooperating UEi is away from the source UE0, a D2D transmission rate between the two may decrease or the transmission may even be interruptted. FIG. 2 is a schematic diagram for illustrating that a rate of device-to-device (D2D) communication changes with a distance between two user equipments (UEs), where (A) schematically illustrates a test scenario in which a distance between two devices changes, (B) illustrates related parameters in a test, and (C) illustrates a graph of D2D (WiFi-Direct used in the test) transmission rate(S) between two devices varying with a distance (D). As illustrated in FIG. 2, as the distance (D) between the two UEs increases, the D2D transmission rate(S) decreases from 118 Mbps to 30 Mbps.

Due to the decrease in the D2D transmission rate, a cooperating UEi cannot effectively utilize its high-speed uplink channel even if such a channel is available. Consequently, its uplink rate will decrease, causing an overall transmission rate of a cooperative system to decrease, and further leading to an impact on the quality (delay, packet reception rate, etc.) or stability of the cooperative transmission.

In view of the above situation, the inventors have proposed the following inventive concept: based on an index of a quality of a cooperative transmission implemented by a current cooperating device (hereinafter also appropriately abbreviated as quality indication index), obtain a status report generated depending on a relationship between the index and first to third ranges that indicate a quality of transmission (hereinafter also appropriately abbreviated as index ranges) for determining an appropriate adjustment to the cooperative transmission, or directly determine an appropriate adjustment to the cooperative transmission depending on the above relationship, thereby facilitating maintaining the quality of the cooperative transmission.

Next, a first embodiment in which a status report is generated depending on a relationship between a quality indication index and a quality indication range, a second embodiment in which an adjustment to the cooperative transmission is determined based on the above status report, and a third embodiment in which an adjustment to the cooperative transmission is directly determined depending on a relationship between the quality indication index and the quality indication range will be described, respectively.

### 2. Configuration Examples of an Electronic Device According to a First Embodiment

### 2.1 Configuration Examples

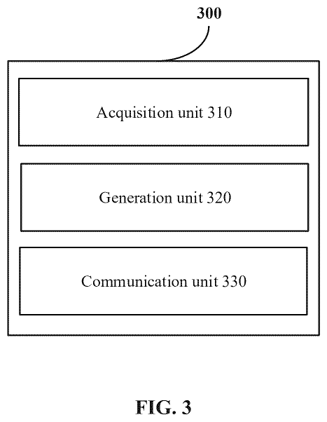

FIG. 3 is a block diagram illustrating a configuration example of an electronic device according to an embodiment of the present disclosure.

As illustrated in FIG. 3, an electronic device 300 may include an acquisition unit 310, a generation unit 320, and a communication unit 330. In addition, although not illustrated in the figure, the electronic device 300 may further include an optional storage unit for storing various programs, data, parameters, and the like.

Here, each unit of the electronic device 300 may be included in a processing circuit. It should be noted that the electronic device 300 may include one processing circuit or may include multiple processing circuit. Further, the processing circuit may include various discrete functional units to perform various different functions and/or operations. It should be noted that these functional units may be physical entities or logical entities, and units of different designations may be implemented by the same physical entity.

The electronic device 300 according to the first embodiment may be a terminal-side device, and may be used for a source device or a cooperating device in the cooperative transmission of FIG. 1A or FIG. 1B. The present disclosure is not limited thereto.

In this configuration example, example processing will be described in further detail in appropriate combination with a case where the electronic device 300 is implemented on a cooperating device (UEi) side in a cooperative transmission system such as illustrated in FIG. 1A or FIG. 1B; these details are similarly applicable to a case where the electronic device 300 is implemented on a source device (UE0) side (differences therebetween will be described in detail in a subsequent section of modification examples, which will not be repeated here).

According to the first embodiment, the acquisition unit 310 of the electronic device 300 may be configured to obtain an index of a quality (quality indication index) of a cooperative transmission implemented by a current cooperating device, the cooperating device relaying a part of data originating from a source device and to be transmitted to a destination device to implement a cooperative transmission. The generation unit 320 may be configured to generate, depending on a relationship between the index and first to third ranges (index ranges) which sequentially indicate qualities of transmission from high to low, a status report about the current cooperating device. The communication unit may be configured to transmit the generated status report to another electronic device.

By means of the above manner, the electronic device 300 may appropriately generate, depending on the obtained quality indication index of the current cooperating device, and transmit, to another electronic device, a status report about the current cooperating device, so as to facilitate another electronic device appropriately determining an adjustment to the cooperative transmission based on the received status report.

Next, further details of parameters or example processing related to each unit of the electronic device will be described.

### Examples/Example Processing Related to the Quality Indication Index Obtained by the Acquisition Unit

By way of example, the quality indication index (Q_{index}) obtained by the acquisition unit 310 may indicate one or more of: a distance between the cooperating device and the source device (D: a first index); a quality of a signal received by the cooperating device from the source device (Q₀: a second index); or a quality of a signal received by the destination device through the cooperative transmission (Q: a third index).

The acquisition unit 310 may obtain the above indexes via various appropriate processing. For example, in a case where the electronic device 300 is implemented on a cooperating device UEi side of FIG. 1A or FIG. 1B (at this time, a UEi corresponding to the electronic device 300 may be referred to as a current cooperating device), the acquisition unit 310 may, for example, obtain a first index D_i by measuring a distance between itself and the source device UE0 via use of various existing distance measurement manners (for example but not limited to a ranging manner based on frequency modulated continuous wave, a ranging method based on a received signal strength index (RSSI), and the like), or obtain a second index Q₀_i by measuring a quality of a signal received by the communication unit 330, where a quality of the received signal may be represented, for example, by a signal-to-interference-plus-noise ratio (SINR), a reference signal received power (RSRP), or a received signal strength index RSSI.

In addition, the acquisition unit 310 may, for example, obtain a third index Q_i from the destination device via the communication unit 330, where the third index Q_i is obtained by measuring a quality of a signal received through the cooperative transmission by the the destination device. As an example of the third index obtained by measurement, a reception signal quality at the destination device may be a general quality index of a signal, represented by, such as SINR, RSRP, or RSSI, that is received by the destination device from the current cooperating device.

As another example of the third index obtained by measurement, a reception signal quality at the destination device may be a specific quality index related to a type of transmission data. For example, in a case where the transmission data is video data, the third index may be a video quality index such as Video Multi-method Assessment Fusion (VMAF); in a case where the transmission data is audio data, the third index may be a corresponding audio quality index, and the like.

In addition to directly obtaining by measurement, in an alternative example, the third index indicating the quality of the signal received by the destination device through the cooperative transmission may be determined by the acquisition unit 310 based on one or more of: a probability of packet retransmission between the source device and the cooperating device; a probability of packet retransmission between the cooperating device and the destination device; and a transmission delay between the cooperating device and the destination device.

In a case where the electronic device 300 itself is for a cooperating device side, its acquisition unit 310 may, for example, obtain the above parameters via communication between the communication unit 330 and the source device and the destination device, which will not be repeated here.

In addition, the acquisition unit 310 may use a quality-index model that has been trained in advance and is stored, for example, in a storage unit not illustrated, and obtain the above third index based on one or more of the above.

More specifically, inputs (model input data) of the quality-index model used by the acquisition unit 310 may include: a probability of packet retransmission between the source device and the current cooperating device; a probability of packet retransmission between the current cooperating device and the destination device; and/or a transmission delay between the current cooperating device and the destination device. An output of the quality-index model may directly indicate a quality (such as VMAF) of a signal received by the destination device via the cooperative transmission, or may indicate a corresponding one among first to third index ranges within which the quality falls (which will be described later). The quality-index model may be implemented, for example, by various neural-network models such as a convolutional neural network (CNN), or machine-learning models such as K-nearest neighbor (KNN) and a support vector machine (SVM).

The quality-index model may be obtained by training, using various appropriate manners, based on labeled training data corresponding to the above model input data.

Here, the model may be trained by using training data of n cooperating UEs (n=1, 2, 3, etc.), that is, the model may have n sets of input channels corresponding to the number of cooperating UEs involved in the training. In application, input data of a current cooperative UE may be copied into corresponding n sets and then input to the model to obtain an output result for the current cooperating UE.

By way of example, the above quality-index model may be trained by a single device such as a source device such as UE0 of FIG. 1A, and be distributed to respective cooperating devices UEi after training is completed, for each cooperating device to store the entire model in its own storage unit. The model may be trained in the following manner: establish a loss function representing a difference between an output result of the model and a true result corresponding to the training data (a true quality such as a value of VMAF labeled for training data, or a corresponding one among first to third index ranges labeled for training data); with the goal of minimizing the loss function, perform iterative training using, for example, a gradient descent method until a predetermined iteration stopping condition is met (for example, the loss function reaches a minimum value, the loss function no longer changes, or a predetermined number of iterations is reached). Model parameters at this time are optimal model parameters, thereby completing iterative training of the quality-index model.

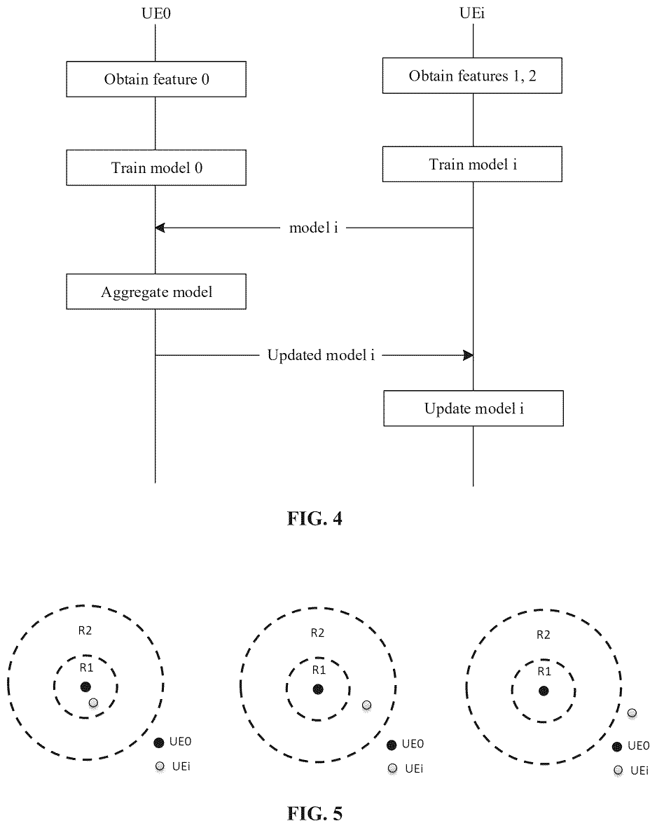

Alternatively, the above quality-index model may also be implemented via federated learning (for example, vertical federated learning). For example, a source device such as UE0 trains a source-device model model0 based on a feature 1 (for example, a probability p₀_i of packet retransmission between the source device and n cooperating UEi), and cooperating devices such as UEi (i=1, 2, . . . n) train cooperating-device models modeli based on features 2 and 3 (for example, a probability p_i of packet retransmission between the cooperating UEi and the destination device such as the aggregation server AS of FIG. 1A, and a transmission delay delay_i from the cooperating UEi to the aggregation server AS); and then the source device performs federation on model0 and modeli to obtain updated model0 and modeli, and distributes modeli to corresponding cooperating devices UEi. FIG. 4 illustrates a flowchart of example signaling interaction for acquiring a quality-index model via federated learning.

In a case where a distributed model is obtained via federated learning, the source device UE0, for example, store the source-device model model0, and cooperating devices UEi and UEj, for example, respectively store its own cooperative-device models modeli and modelj, where j is the coordination device number not equal to i. At this time, the acquisition unit 310 of the electronic device 300 applied to the cooperating device UEi may use the communication unit 330 to transmit a corresponding part of its obtained model input data to UE0, and UE0 may forward it to other cooperating devices UEj as necessary (for example, UE0 uses, in the model model0, the probability p0_i of packet retransmission between UE0 and UEi, and transmits, to UEj, the probability p_i of packet retransmission between UEi and the destination device, and the transmission delay delay_i from UEi to the destination device), and receive from UE0 output results of respective models (for example, the output result of model0 directly obtained by the UE0 and the output result of modelj obtained from UEj), and then obtain a final quality indication index by, for example, a weighted average manner in combination with the output result of its own model modeli.

In the above, examples have been described in which the acquisition unit 310 of the electronic device 300 directly determines (or estimates) the quality indication index such as VMAF (or the range to which it belongs) by using a pre-trained quality-index model based on related parameters such as probabilities of packet retransmission. However, the present disclosure is not limited thereto. For example, a quality-index database may be established based on historical data corresponding to training data in the process of acquiring the model, and a third index such as VMAF (or the range within which it falls) corresponding to current related parameters such as probabilities of packet retransmission may be determined by using the similarity between the current related parameters and entries in the database, so that related training processing is omitted, which will not be repeated here.

Compared with a case where the acquisition unit 310 of the electronic device 300 receives, from a destination device, a third index such as VMAF regarding real-time transmission of, for example, video-stream data (this case means that a process in which the destination device receives the video stream, calculates VMAF, and then feeds back the VMAF to the electronic device 300 must be undergone), a manner in which the acquisition unit 310 directly determines (or estimates), for example by using a pre-trained model, a third index such as VMAF based on related parameters such as probabilities of packet retransmission can be performed in synchronization with transmission of, for example, video-stream data, thereby facilitating optimizing the process and reducing video transmission delay.

The above respective indexes such as first to third indexes and the acquisition manners thereof may be applied to various cooperative transmission systems, for example but not limited to the systems illustrated in FIGS. 1A and 1B. In addition, the above-obtained quality indication indexes can be favorably applied in various manners, for example, to generate, by the generation unit 320, a status report about a cooperating device as will be further described later. However, these quality indication indexes are not limited thereto, but may be used as general indications regarding a quality of the cooperative transmission and be applied in manners not mentioned herein.

### Examples/Example Processing Related to the Generation Unit

When generating a status report about the current cooperating device, the generation unit 320 compare a quality indication index (Q_{index}) regarding the current cooperating device with first to third ranges (index ranges) which sequentially indicate qualities of transmission from high to low, so as to generate a corresponding status report depending on the relationship between them, that is, depending on which range the index falls within.

### (Examples of Index Ranges)

First to third ranges serving as the index ranges may be divided based on a first threshold and a second threshold (index thresholds: Thre1, Thre2, where Thre1<Thre2) of the quality indication index (Q_{index}), that is, a first or third range of Q_{index}<Thre1, a second range of Thre1≤Q_{index}≤Thre2, and a third or first range of Q_{index}>Thre2, where specific definitions of first range and third range depend on which one among the foregoing first to third indexes D, Q₀, and Q is specifically adopted as the index Q_{index}. When the index is the first index D indicating distance, Q_{index}<Thre1 is a first range of the highest communication quality, and Q_{index}>Thre2 is a third range of the lowest communication quality; when the index is the second or third index Q₀ or Q indicating reception signal quality, Q_{index}>Thre2 is a first range of the highest communication quality, and Q_{index}<Thre1 is a third range of the lowest communication quality.

In a case where the electronic device 300 is applied to a cooperating device, the device may obtain the above index thresholds or ranges from, for example, the source device (or the destination device) via the communication unit 330, and store them in advance in the storage unit (not illustrated) of the electronic device 300. These index thresholds or ranges may be determined, for example, by the source device (or the destination device) separately for each cooperating device and then distributed correspondingly to each cooperating device (for example, to favor consideration of unique attributes that may exist in each device), or may be determined for one of the cooperating devices and then uniformly distributed to the respective cooperating devices (for example, to favor simplification of processing).

By way of example, the above index thresholds may be determined in the following manner: appropriately determine first and second thresholds (parameter thresholds) of various parameters related to a quality of the cooperative transmission based on various factors such as performance requirements of a system, and determine first and second index thresholds corresponding to the above parameter thresholds based on correspondences between each index (D, Q₀, Q) and a corresponding parameter.

Here, by way of example, parameters related to the quality of the cooperative transmission may include: a first parameter, such as a transmission rate S between the cooperating device and the source device; a second parameter, a quality Q₀ of a signal received by the cooperating device from the source device; a third parameter, the number Nᵣₑ of retransmissions between the cooperating device and the source device; and a fourth parameter, a quality Q of a signal received by the destination device through the cooperative transmission, and the like. These parameters and corresponding parameter thresholds thereof (that is, index thresholds determined accordingly and corresponding index ranges) may be applicable to example application scenarios illustrated in FIG. 1A or FIG. 1B.

In this specification, parameter thresholds of each parameter (S, Q₀, Nᵣₑ, Q) related to the quality of the cooperative transmission may be critical parameter values at which a quality of transmission of the cooperative transmission starts to deteriorate and deteriorates severely, so as to be used to divide first to third parameter ranges of each parameter, which respectively correspond to high, medium, and low quality of transmission. That is, the first parameter range indicates that the cooperative transmission has the highest quality and the cooperative transmission does not need to be adjusted; the third parameter range indicates that the cooperative transmission has the lowest quality, leading to an impact on stability of the cooperative transmission system (for example but not limited to an overall rate being insufficient, an increase in packet loss rate, an increase in delay, and the like), the current cooperating device needs to exit the cooperative transmission, and an appropriate adjustment may need to be made to the cooperative transmission; the second parameter range between the two indicates that the cooperative transmission has a medium quality, the current cooperating device may be retained in the cooperative transmission system, but an appropriate adjustment may need to be made to the cooperative transmission.

Next, examples of various parameter thresholds and meanings thereof will be described in detail in conjunction with example applications of FIG. 1A and FIG. 1B.

### (Examples of Parameter Thresholds of First Parameter)

For a case of a transmission rate S between the cooperating device UEi and the source device UE0 as illustrated in FIG. 1A or FIG. 1B as the first parameter, parameter thresholds thereof may be thresholds as follows: a first threshold S1 is a critical value at which the transmission rate S basically has no deterioration, for example, indicating that the transmission rate S basically remains unchanged or a change therein does not affect an uplink transmission rate (abbreviated as an “uplink rate”) SpeedUL_i of UEi and thus does not affect an uplink rate SpeedUL of the entire cooperative transmission system, where SpeedUL=ΣSpeedUL_i; a second threshold S2 is a critical value at which the transmission rate S deteriorates severely, for example, indicating that a change in the transmission rate S causes the uplink transmission rate SpeedUL_i of UEi to decrease to an intolerable level and thus causes the uplink rate SpeedUL of the entire cooperative transmission system to be insufficient.

Accordingly, when the transmission rate S_i between UEi and UE0 satisfies S_i>S2, no adjustment needs to be made to the cooperative transmission system; when S1≤S_i≤S2, it is desired to make an adjustment to the cooperative transmission, for example to increase an overall uplink rate; when S_i<S1, it is desired to cause the current cooperating device to exit the cooperative transmission, and it may also be desired to make an adjustment to a transmission rate, a transmission amount, and the like of other cooperating devices in the cooperative transmission system and/or add a new cooperating device so as to increase the overall uplink rate.

### (Examples of Parameter Thresholds of Second Parameter)

For a case of a quality Q₀ of a signal received by the cooperating device UEi from the source device UE0 as illustrated in FIG. 1A or FIG. 1B as the second parameter, parameter thresholds thereof may be thresholds as follows: a first threshold Q₀1 is a critical value at which a reception signal quality Q₀ of UEi basically has no deterioration, for example, indicating that a quality of transmission of the cooperative transmission via UEi basically has no deterioration; a second threshold Q₀2 is a critical value at which a reception signal quality Q₀ of UEi deteriorates severely, for example, indicating that a quality of transmission of the cooperative transmission via the UEi deteriorates severely.

Accordingly, when the reception signal quality Q₀ of the signal received by the cooperating device UEi from the source device UE0 is sufficiently high, that is, Q₀_i>Q₀2, no adjustment needs to be made to the cooperative transmission system; when Q₀1≤Q₀_i≤Q₀2, it is desired to make an adjustment to the cooperative transmission, for example to improve the quality of transmission; when Q₀_i<Q₀_1, it is desired to cause the current cooperating device to exit the cooperative transmission, and it may also be desired to make an adjustment to other cooperating devices in the cooperative transmission system and/or add a new cooperating device so as to improve the quality of the cooperative transmission (for example, to increase an overall uplink rate and the like).

Here, for example, in an example application illustrated in FIG. 1B, when the source device UE0 and the cooperating device UEi communicate via Sidelink, frequency resources for this communication may be switchable between a first frequency band and a second frequency band lower than the first frequency band. By way of example, the first frequency band may be a high frequency band of Frequency Range 2 (FR2), for example, from 24.25 GHz to 52.6 GHz, in which spectrum resources are more and beam communication is used, thereby bringing higher throughput and reception signal quality. The second frequency band may be a low frequency band of Frequency Range 1 (FR1), for example, from 410 MHz to 7125 MHz, in which omnidirectional communication can be used.

In this case, the above reception signal quality threshold Q₀2 may indicate a critical value at which the reception signal quality of communication in first frequency band starts to deteriorate (for example, a Sidelink connection in the FR2 band becomes worse) (and optionally, for example, a quality of a reception signal of communication in the second frequency band of the FR1 band remains relatively good), and Q₀1 may indicate a critical value at which the reception signal quality of communication in the second frequency band deteriorates severely (for example, a Sidelink connection in the FR1 band becomes unstable or even interrupted).

Accordingly, in this example, when Q₀_i>Q₀2, a Sidelink connection quality, for example, in the FR2 band between UE0 and UEi is relatively good, and at this time, no adjustment needs to be made to the cooperative transmission system and, for example, Sidelink communication in the FR2 band may be maintained. When Q₀1≤Q₀_i≤Q₀2, it indicates that a Sidelink connection of the higher first frequency band such as the FR2 band becomes worse, and it is desired to make an adjustment to the cooperative transmission, for example to switch frequency resources of Sidelink communication to the lower second frequency band such as the FR1 band. When Q₀_i<Q₀1, a Sidelink connection, for example, in the FR1 band between UE0 and UEi also deteriorates greatly, and at this time, UEi needs to exit the cooperative transmission, and it may also be desired to make an adjustment to other cooperating devices in the cooperative transmission system and/or add a new cooperating device so as to improve the quality of the cooperative transmission (for example, to increase an overall uplink rate and the like).

### (Examples of Parameter Thresholds of Third Parameter)

For a case of a number Nᵣₑ of retransmissions between the cooperating device UEi and the source device UE0 as illustrated in FIG. 1B as the third parameter, parameter thresholds thereof may be thresholds as follows: a first threshold Nᵣₑ1 is a critical value at which the number Nᵣₑ of retransmissions (the number of times of transmitting Hybrid Automatic Repeat request (HARQ)) is low, for example, indicating that no additional feedback resources need to be allocated for direct communication such as Sidelink communication between UEi and UE0, while the communication quality therebetween can still be maintained; a second threshold Nᵣₑ2 may be a critical value at which the number Nᵣₑ of retransmissions is excessively high, which may be, for example, an upper limit value of the number of times of transmitting HARQ, and at this time, even if more feedback resources are allocated for Sidelink communication between UEi and UE0, the communication quality therebetween still cannot be maintained.

Accordingly, when the number Nᵣₑ of retransmissions between UEi and UE0 satisfies the condition Nᵣₑ_i<Nᵣₑ1, no adjustment needs to be made to the cooperative transmission; when Nᵣₑ1≤Nᵣₑ_i≤Nᵣₑ2, it is desired that a network-side device such as a gNB make an adjustment to the cooperative transmission to allocate more feedback resources for Sidelink communication so as to meet a demand of a larger number of retransmissions; when Nᵣₑ_i>Nᵣₑ_2, it is desired to cause the current cooperating device to exit the cooperative transmission, and it may also be desired to make an adjustment to other cooperating devices in the cooperative transmission system and/or add a new cooperating device so as to increase an overall uplink rate.

### (Examples of Parameter Thresholds of Fourth Parameter)

For a case of a quality Q of a signal received by the destination device AS or gNB through the cooperative transmission as illustrated in FIG. 1A or FIG. 1B as the fourth parameter, parameter thresholds thereof, that is, a first threshold Q1 and a second threshold Q2, may be critical values at which a reception signal quality Q basically has no deterioration and deteriorates severely, respectively.

When a quality Q of a signal received by the destination device AS or gNB through the cooperative transmission is sufficiently high, that is, Q_i>Q2, no adjustment needs to be made to the cooperative transmission system. When Q1≤Q_i≤Q2, it is desired to make an adjustment to the cooperative transmission, for example to improve the quality of transmission. When Q_i<Q_1, it is desired to cause the current cooperating device to exit the cooperative transmission, and it may also be desired to make an adjustment to other cooperating devices in the cooperative transmission system and/or add a new cooperating device so as to increase an overall uplink rate.

The above parameter thresholds of the fourth parameter may be particularly suitable for a case of transmitting various service data such as video data and the like. In this case, the first threshold Q1 and the second threshold Q2 may be critical values at which a video signal quality received by the destination device basically has no deterioration and deteriorates severely, respectively, and may have, for example, a form of a video quality parameter such as VMAF.

First and second thresholds (index thresholds) of the quality indication index for dividing first to third index ranges may be determined based on correspondences between each index (D, Q₀, Q) and, for example, the above first to fourth parameters and corresponding parameter thresholds. Examples of the index thresholds will be described next in detail.

### (Examples of Index Thresholds)

By way of example, a first range, a second range, and a third range (index ranges) of the quality indication index may be divided based on a first threshold and a second threshold (index thresholds) of the index determined based on the following thresholds (that is, corresponding parameter thresholds): the first threshold and the second threshold of the transmission rate between the cooperating device and the source device (parameter thresholds S1 and S2 of the first parameter S); the first threshold and the second threshold of the quality of the signal received by the cooperating device from the source device (parameter thresholds Q₀1 and Q₀2 of the second parameter Q₀); the first threshold and the second threshold of the number of retransmissions between the cooperating device and the source device (parameter thresholds Nᵣₑ1 and Nᵣₑ2 of the third parameter Nᵣₑ); and/or the first threshold and the second threshold of the quality of the signal received by the destination device through the cooperative transmission (parameter thresholds Q1 and Q2 of the fourth parameter Q).

That is, for each index among the foregoing first to third indexes (D, Q₀, Q), index thresholds may be determined based on correspondences between each index and one or more of the above four parameters and corresponding index thresholds of the one or more parameters.

On one hand, when the quality indication index is the same as a parameter used to determine index thresholds (that is, as a basis for dividing index ranges), it is unnecessary to additionally obtain a correspondence therebetween, and parameter thresholds of the parameter may be directly used as index thresholds. For example, the second index and the second parameter both indicating a quality of a signal received by the cooperating device from the source device, or the third index and the fourth parameter both indicating a quality of a signal received by the destination device through the cooperative transmission, fall into this case.

On the other hand, when the quality indication index is different from a parameter used to determine index thresholds (that is, as a basis for dividing index ranges), for example, a correspondence therebetween may be obtained via historical data including the index and the corresponding parameter. A correspondence between the index and the corresponding parameter (or between index thresholds and corresponding parameter thresholds) may be obtained via measurement and statistics, or may be obtained via a model trained using combinations of labeled indexes and parameters.

Next, specific examples of index thresholds of first to third indexes will be further described in conjunction with examples of FIG. 1A and FIG. 1B.

For example, first and second thresholds (R1 and R2) of the first index (the distance index D) indicating the distance between the cooperating device UEi and the source device UE0 may be determined based on the above first, second, or third parameter (S, Q₀, Nᵣₑ), so as to respectively correspond to first and second thresholds (S1 and S2) of the first parameter, that is, the transmission rate S between UEi and UE0, second and first thresholds (Q₀2 and Q₀1) of the second parameter, that is, the quality Q₀ of the signal received by UEi from UE0, or first and second thresholds (Nᵣₑ1 and Nᵣₑ2) of the third parameter, that is, the number Nᵣₑ of retransmissions between UEi and UE0.

In one example, corresponding index thresholds R1 and R2 may be obtained via measurement and statistics. For example, the first parameter (the transmission rate S between UEi and UE0), the second parameter (the quality Q₀ of the signal received by UEi from UE0), or the third parameter (the number Nᵣₑ of retransmissions between UEi and UE0) at different distance values between UEi and UE0 may be measured, and a distance value between UEi and UE0 corresponding to parameter thresholds (S1 and S2; Q₀2 and Q₀1; or Nᵣₑ1 and Nᵣₑ2) of each parameter may be obtained statistically.

In another example, index thresholds R1 and R2 may be obtained by using a model obtained by machine learning using historical data (that is, measurement data as training data) including various distances between UEi and UE0 and corresponding parameter values of each parameter (S; Q₀; or Nᵣₑ) measured for each distance. After training is completed, inputs of the model are parameter thresholds (S1 and S2; Q₀2 and Q₀1; or Nᵣₑ1 and Nᵣₑ2) of each parameter, and outputs are index thresholds R1 and R2 corresponding to the parameter thresholds. This may be implemented by using various appropriate neural networks or machine-learning models and appropriate training, which will not be repeated here.

Alternatively, first and second thresholds R1 and R2 of the distance index D may also be two or three sets of index thresholds obtained based on parameter thresholds of two or three parameters among the above first parameter, second parameter, and third parameter. The two or three sets of index thresholds are then processed appropriately to obtain comprehensive thresholds. Here, the appropriate processing may be a weighted average, or a manner of selecting a smallest first index threshold among the respective sets of index thresholds as the first index threshold and selecting a largest second index threshold among the respective sets of index thresholds as the second index threshold, and the like. The present disclosure does not limit this.

FIG. 5 illustrates an example of index ranges divided based on the index thresholds R1 and R2 of the distance index. As illustrated in FIG. 5, three ranges are divided based on a relationship between a distance (D_i) between a source device UE0 and a cooperating device UEi and first and second thresholds R1 and R2 of the index: a first range of D_i<R1; a second range of R1≤D_i≤R2; and a third range of D_i>R2, wherein each range corresponds, for example but not limited to, to a range in which the first, second, or third parameter (S, Q₀, Nᵣₑ) basically has no deterioration, a range in which the deterioration degree of the above parameters is tolerable, and a range in which the above parameters deteriorates severely.

In addition, for example, first and second thresholds (Q₀1 and Q₀2) of a second index (Q₀) indicating a quality of a signal received by a cooperating device UEi from a source device UE0 may be determined based on the above second or third parameter (Q₀, Nᵣₑ), so as to respectively correspond to first and second thresholds (Q₀1 and Q₀2) of the second parameter, that is, a quality Q₀ of a signal received by UEi from UE0, or second and first thresholds (Nᵣₑ2 and Nᵣₑ1) of the third parameter, that is, a number Nᵣₑ of retransmissions between UEi and UE0.

For a case of using a parameter that is the same as the second index, that is, the case of using the second parameter, parameter thresholds Q₀1 and Q₀2 may be directly used as index thresholds Q₀1 and Q₀2.

For a case of using a parameter that is different from the second index, that is, the case of using the third parameter, in one example, corresponding index thresholds Q₀1 and Q₀2 may be obtained via measurement and statistics. For example, a third parameter Nᵣₑ (the number of retransmissions between UEi and UE0) at different values of a quality of a signal received by UEi from UE0 may be measured, and reception signal qualities Q₀2 and Q₀1 corresponding to parameter thresholds Nᵣₑ1 and Nᵣₑ2 may be obtained statistically. In another example, index thresholds R1 and R2 may be obtained by using a model obtained by machine learning using historical data (that is, measurement data as training data) including various values of a quality of a signal received by the UEi from the UE0 and corresponding parameter values of a third parameter Nᵣₑ (the number of retransmissions) measured for each value. After training is completed, inputs of the model are parameter thresholds (Nᵣₑ2 and Nᵣₑ1) of the third parameter, and outputs are index thresholds Q₀1 and Q₀2 corresponding to the parameter thresholds. This may be implemented by using various appropriate neural networks or machine-learning models and appropriate training, which will not be repeated here.

Alternatively, first and second thresholds Q₀1 and Q₀2 of the second index Q₀ may also be comprehensive thresholds obtained by obtaining two sets of index thresholds respectively based on parameter thresholds of the above second parameter and third parameter and then processing via an appropriate manner. Here, the appropriate processing may be a weighted average, or a manner of selecting a smallest first index threshold among the respective sets of index thresholds as the first index threshold and selecting a largest second index threshold among the respective sets of index thresholds as the second index threshold, and the like. The present disclosure does not limit this.

In addition, it can be understood that parameter thresholds Q1 and Q2 of the fourth parameter may be directly used as first and second thresholds (Q1 and Q2) of a third index (Q) indicating a quality of a signal received by a destination device through a cooperative transmission.

Each index threshold determined via, for example, the above manners and the correspondingly divided index ranges may be applied, together with a corresponding index obtained in real time, to various cooperative transmission systems, for example but not limited to the systems illustrated in FIG. 1A and FIG. 1B. This will not be repeated here.

Index ranges divided based on first and second index thresholds determined via the above manners are a first range indicating the highest cooperative quality of transmission (the cooperative transmission does not need to be adjusted), a third range indicating the lowest cooperative quality of transmission (the current cooperating device needs to exit the cooperative transmission), and a second range indicating a medium cooperative quality of transmission (the current cooperating device may be retained in the cooperative transmission system, but the cooperative transmission needs to be adjusted). Therefore, the generation unit 320 may generate a status report correspondingly depending which range the quality indication index falls within, and the status report may be used by another electronic device to determine an adjustment to the cooperative transmission.

### (Examples of Generating a Status Report)

As described above, the generation unit 320 may generate a status report correspondingly based on which range among first to third ranges the quality indication index (Q_{index}) falls within.

For example, the generation unit 320 may be configured to: in a case where the index falls within the first range indicating the highest quality of transmission, generate no status report; in a case where the index falls within the second range indicating medium quality of transmission, generate a first status report; and/or in a case where the index falls within the third range indicating the lowest quality of transmission, terminate communication between the cooperating device and the source device, and generate a second status report.

In this manner, the case where the generation unit 320 does not generate any status report may indicate an optimal state of the highest quality of transmission. The generated first and second status reports may, for example, use one bit to respectively indicate a first state of medium quality of transmission and a second state of the lowest quality of transmission.

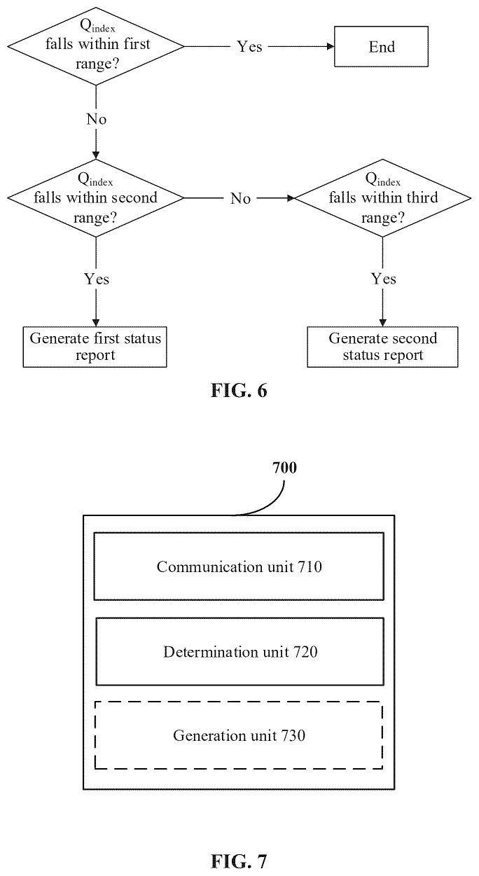

FIG. 6 illustrates an example flow of the generation unit 320 generating first and second states correspondingly based on a comparison between the quality indication index Q_{index} and first to third ranges, which will not be repeated here.

Optionally, in a case where the acquisition unit 310 of the electronic device 300 may obtain multiple indexes and multiple sets of corresponding index thresholds or index ranges may be stored in a storage unit (not illustrated), and the generation unit 320 generates a status report based on a comparison between a corresponding index and a corresponding index range, the generated status report may further include first additional information regarding a currently used index (for example, two bits indicating one of first to third indexes D, Q₀, and Q) and/or second additional information regarding a parameter used to divide a currently used index range (for example, two bits indicating one of first to fourth parameters S, Q₀, Nᵣₑ, and Q).

For example, a status report generated by the generation unit 320 may have a form of a bit sequence of a length of 5, where, in addition to the first bit indicating the first or second state of quality of transmission, first and second additional information of 4 bits are further used to indicate further details of a current cooperative transmission to a receiver of the status report. For example, the generation unit 320 may generate a first status report having a form such as {00010} or {00110}, which, in addition to the first bit (0) indicating the first state of quality of transmission, further uses the second and the third bit (00 or 01) to indicate the second or third index (D or Q₀), and uses the fourth and the fifth bit (10) to indicate the third parameter (Nᵣₑ) used to divide a current index range.

### Examples/Example Processing Related to the Communication Unit

The communication unit 330 may transmit the first or a second status report generated by the generation unit 320 via example processing as illustrated in FIG. 6 to another electronic device, enabling the latter to make a corresponding adjustment to the cooperative transmission. In addition, in a case where the generation unit 320 generates the second status report, for example, the communication unit 330 of the electronic device 300 used as a source device or a current cooperating device may directly terminate direct communication between the source device and the current cooperating device, causing the current cooperating device to exit the cooperative transmission.

In this example, the electronic device 300 is used as the current cooperating device (or the source device), and the “another electronic device” here may be a device that manages a cooperative transmission (a cooperation management device) such as the destination device, for example, the aggregation server AS or the base station gNB as illustrated in FIG. 1A or FIG. 1B. The destination device may determine an adjustment to the cooperative transmission based on the received status report, further generate an adjustment notification instructing the adjustment to the cooperative transmission, and transmit the generated adjustment notification to the cooperating device and/or the source device. Accordingly, after receiving the adjustment notification (directly from another electronic device or, for example, forwarded by the source device), the communication unit 330 of the electronic device 300 may perform the adjusted cooperative transmission according to the instruction of the adjustment notification.

Here, first consider an application example particularly suitable for example applications as illustrated in FIG. 1B, in which the communication unit receives a first adjustment notification generated by another electronic device based on the first status report.

In this application example, another electronic device serving as a cooperation management device may be a network-side device, for example, a base-station-side device gNB, communication between the source device and the cooperating device may be performed via a sidelink (Sidelink), and, for example, a network-side device such as a gNB may allocate communication resources for Sidelink communication.

In one example, at this time, the first status report generated by the generation unit 320 that the communication unit 330 transmits to another electronic device may, in addition to indicating a first state to indicate medium quality of transmission, also indicate, via first and second additional information, a second or third index currently used (D or Q₀) and a third parameter (the number Nᵣₑ of retransmissions between the source device and the cooperating device) used to divide a current index range. In another example, the first status report that the communication unit 330 transmits to another electronic device may, in addition to indicating first state, also indicate, via first and second additional information, a second index (Q₀) currently used and a second parameter (a quality Q₀ of a signal received by a cooperating device from a source device) used to divide a current index range. The above first status report may, for example, have a form of a bit sequence such as {00010} or {00110}.

In the above two example cases, another device that receives the corresponding first status report may determine, based on the first status report, to adjust resources allocated for the current sidelink communication between the current cooperating device and the source device (a first adjustment), and generate a first adjustment notification instructiong the adjustment. Here, the first adjustment may include: increasing feedback resources allocated to the current cooperating device for the current sidelink communication (feedback resource adjustment); and/or switching frequency resources allocated for the current sidelink communication from a first frequency band to a second frequency band lower than the first frequency band (a frequency-band adjustment). Whether to make the first adjustment specifically for feedback resources or for the frequency band may be specifically determined by another electronic device, for example, based on the second additional information included in the received first status report. That is, when the second additional information indicates the third parameter as the number Nᵣₑ of retransmissions, the first adjustment is implemented as the feedback resource adjustment, and when the second additional information indicates the second parameter as the reception signal quality Q₀, the first adjustment is implemented as the frequency-band adjustment.

In addition, in the above two example cases, the communication unit 330 may be configured to: receive a first adjustment notification generated by another electronic device based on the first status report, the notification instructing an adjustment to communication resources allocated for the current sidelink communication between the current cooperating device and the source device. For example, the first adjustment notification may correspondingly instruct an allocation of increased feedback resources for the current sidelink communication to the current cooperating device, or instruct an allocation of frequency resources in a second frequency band (for example, an FR1 band) lower than a first frequency band (for example, an FR2 band) currently used for the current sidelink communication.

Here, the first adjustment notification may have various appropriate forms. For example, it may be configuration information of a base-station-side device for reconfiguration of the sidelink communication or a dynamic Downlink Control Information (DCI) indication. The present disclosure does not impose a limitation thereon.

More specifically, periodic feedback resources allocated by a network-side device such as a gNB for Sidelink communication between UEi and UE0 may be indicated via configuration information (for example, a parameter indicating a period of feedback resources in a configured resource pool), or may be indicated dynamically via DCI and the like. The gNB may allocate more feedback resources for Sidelink communication by modifying configuration information such as feedback resources (a feedback resource period), or by switching to a shorter feedback resource period in real time via DCI when there are multiple configurations regarding feedback resources (a feedback resource period) and the like. Similarly, a switch of frequency resources such as from a first frequency band to a second frequency band may also be implemented by the gNB modifying configuration information regarding frequency resources, or, switching to a lower second frequency band in real time via DCI when there are multiple frequency resource configurations and the like. Accordingly, a first adjustment notification received by the communication unit 330 may have a form of configuration information or dynamic DCI as described above.

The communication unit 330 that receives the above first adjustment notification may use adjusted communication resources to continue current sidelink communication between the current cooperating device and the source device so as to improve the communication quality. For example, the communication unit 330 may use increased feedback resources, allocated for the current sidelink communication by the adjustment notification, to perform transmission of HARQ requests therebetween, so as to meet a demand of a larger number of HARQ requests; or the communication unit 330 may switch to a second frequency band (for example, an FR1 band), allocated by the adjustment notification for the current sidelink communication, lower than a first frequency band (for example, an FR2 band) currently used to perform the current sidelink communication, and optionally switch beam communication of a higher frequency band to omnidirectional communication of a lower frequency band, so as to avoid continuing to apply an unsuitable high frequency band and/or beam communication to the current sidelink.

In this manner, the quality of current sidelink communication between the current cooperating device and the source device can be improved, thereby favoring improvement of a quality of transmission of the cooperative transmission.

Next, consider an application example suitable for example applications as illustrated in both FIG. 1A and FIG. 1B, in which the communication unit receives a second adjustment notification generated by another electronic device based on the second status report, and the notification instruct the current cooperating device to exit the cooperative transmission.

In one example, at this time, the second status report generated by the generation unit 320 that the communication unit 330 transmits to another electronic device may indicate a second state using only one bit (1), so as to indicate that a quality of transmission of the cooperative transmission via the current cooperating device UEi deteriorates severely. Accordingly, another device that receives the second status report may determine, based on the second status report, to cause the current cooperating device to exit the cooperative transmission (a second adjustment), and generate a second adjustment notification instructing the adjustment, so as to instruct the current cooperating device to exit the cooperative transmission.

The communication unit 330 that receives the above second adjustment notification may determine to terminate current sidelink communication between the current cooperating device and the source device, and thus cause the current cooperating device to exit the cooperative transmission. In this manner, it is possible to prevent a current cooperating device that is unsuitable from continuing to retain in the cooperative transmission system and causing a decrease in quality of transmission.

In addition, the following situation also exists: after the communication unit 330 of the electronic device 300 for a current cooperating device such as the UEi transmits the first or the second status report to another electronic device, another electronic device may determine an additional adjustment to the cooperative transmission system that is different from the foregoing first or second adjustment. Here, the additional adjustment determined by another electronic device may include, for example but not limited to, increasing a transmission amount and/or a transmission rate of one or more other cooperating devices in the cooperative transmission, and/or adding a new cooperating device to the cooperative transmission, and the like. Said another electronic device may generate an additional adjustment notification instructing the additional adjustment, and may transmit the additional adjustment notification to the source device and other or new cooperating device UEj other than the current cooperating device UEi. In this case, the communication unit of the electronic device 300 for the current cooperating device UEi may not receive the above additional adjustment notification.

### 2.2 Modification Examples

On the basis of the above-described configuration example of the electronic device 300 according to the first embodiment, those skilled in the art can understand that various appropriate modifications may be made.

For example, it has been described above that the acquisition unit 310 may use a pre-trained quality-index model, take a probability of packet retransmission between a source device and a cooperating device and/or a probability of packet retransmission, and/or a transmission delay between a cooperating device and a destination device as input data of the model, to obtain an index (a third index Q) of a quality of a signal received by the destination device, and the generation unit 320 may determine to generate no status report or appropriately generate a first or a second status report based on a comparison between the third index and index ranges determined based on corresponding index thresholds (Q1 and Q2).

In a modification example, the quality-index model may be modified or transformed into a classification model. That is, input data of a quality-index model serving as a classification model remains unchanged, but an output result of the model directly indicates one among first to third ranges serving as index ranges within which the third index obtained based on these parameters falls. The model may be obtained by training using corresponding training data (historical parameters whose classification results are labeled as one among first to third ranges). This will not be repeated here.

In this case, the acquisition unit 310 may obtain only various parameters as input data of the classification model, and the generation unit 320 may use the above classification model to obtain a range within which a corresponding third index (Q) falls, and then perform necessary processing of generating a status report based on the range. This will not be repeated here.

In addition, in part of the description of the configuration example of the electronic device 300 described above, a case where the electronic device 300 is applied to a cooperating device (such as UEi of FIG. 1A or FIG. 1B), and another electronic device that manages or adjusts cooperative communication is a destination device (such as the aggregation server AS of FIG. 1A or the base station gNB of FIG. 1B) has been described as an example. However, in an application example such as FIG. 1A, a source device (such as UE0) may serve as another electronic device that manages or adjusts the cooperative communication, which will not be described in detail here.

In addition, although the above-described configuration example of the electronic device 300 mainly takes a case where the electronic device 300 is applied to a cooperating device (such as UEi of FIG. 1A or FIG. 1B) as an example, those skilled in the art can understand, based on the above description, that a modification example in which the electronic device 300 is similarly or analogously applied to a source device (such as UE0 of FIG. 1A or FIG. 1B) can be obtained via appropriate modifications and/or transformations.

For example, in a modification example, the acquisition unit 310 of the electronic device 300 on the UE0 side may obtain quality indication indexes (D, Q₀, Q) via various appropriate manners. For example, in addition to obtaining a first index D_i via self measurement (such as measuring a distance between UE0 and UEi), the acquisition unit 310 of the electronic device 300 on the UE0 side may further use a communication unit 330 to obtain, from a current cooperating device UEi, a second index Q₀_i that is obtained by the UEi by measuring a quality of a received signal, or may, for example, use the communication unit 330 to obtain, from a destination device, a third index Q_i that is obtained by the destination device by measuring a quality of a signal received via a cooperative transmission. In addition, the acquisition unit 310 may similarly obtain third index Q_i by using the previously described quality-index model, which will not be elaborated here.

Furthermore, in a modification example, an adjustment notification that a communication unit 330 of the electronic device 300 on the UE0 side receives from another electronic device such as a destination device may further include an additional adjustment notification generated based on the first or the second status report, the adjustment notification instructs an increase in the transmission amount and/or transmission rate of one or more other cooperating devices in the cooperative transmission (a first additional adjustment notification), and/or the addition of a new cooperating device to the cooperative transmission (a second additional adjustment notification).

Accordingly, upon receiving the first additional adjustment notification, the communication unit 330 may, for example, according to an instruction of the notification, perform data transmission to the cooperating device indicated by the instruction with an increased transmission amount so as to increase a transmission amount of the cooperating device in the cooperative transmission, or may also perform transmission between the two (such as Sidelink transmission) at an increased transmission rate. Upon receiving the second additional adjustment notification, the communication unit 330 may, for example, establish communication (such as Sidelink communication) with a new cooperating device indicated by the instruction, and perform cooperative transmission via the new cooperating device.

The above describes the electronic device according to the first embodiment of the present disclosure. The electronic device (electronic device 300) may be used on a source device side or a cooperating device side, and is capable of generating a status report depending on a relationship between a quality indication index and an index range and transmitting the generated status report to another electronic device for managing the cooperative transmission (particularly direct communication between a cooperating device and a source device), for said another electronic device to determine an adjustment to the cooperative transmission, and optionally performing the adjusted cooperative transmission based on the adjustment notification transmitted by said another electronic device.

In the above description process of the first embodiment, in addition to the electronic device 300 for generating and transmitting a status report to another electronic device, another electronic device (for example, a destination device in a basic example and a source device in a modification example, and the like) that determines an adjustment to the cooperative transmission based on the received status report is also described. In other words, the inventors have made a second embodiment of the present disclosure for the above another electronic device. Hereinafter, on a basis of the description of the first embodiment, an outline description of the second embodiment will be given, and unnecessary details thereof are omitted.

### 3. Configuration Examples of an Electronic Device According to a Second Embodiment

### 3.1 Configuration Examples

FIG. 7 is a block diagram illustrating a first configuration example of an electronic device according to a second embodiment of the present disclosure.

As illustrated in FIG. 7, an electronic device 700 may include a communication unit 710 and a determination unit 720, and may further include an optional generation unit 730. In addition, although not illustrated in the figure, the electronic device 700 may further include an optional storage unit for storing various programs, data, parameters, and the like.

Here, each unit of the electronic device 700 may be included in a processing circuit. It should be noted that the electronic device 700 may include one processing circuit or may include multiple processing circuitries. Further, the processing circuit may include various discrete functional units to perform various different functions and/or operations. It should be noted that these functional units may be physical entities or logical entities, and units with different appellations may be implemented by a same physical entity.

The electronic device 700 in the first configuration example may be a network-side device or a terminal-side device, and may be used as a destination device or a source device in the cooperative transmission of FIG. 1A or FIG. 1B. The present disclosure does not impose a limitation thereon.

The communication unit 710 of the electronic device 700 may be configured to: receive a status report about a current cooperating device, the cooperating device relaying a part of data originating from a source device and to be transmitted to a destination device to implement a cooperative transmission. The status report received by the communication unit 710 is generated depending on a relationship between the index of the quality of the cooperative transmission (the quality indication index) implemented by the current cooperating device and first to third ranges (index ranges) which sequentially indicate qualities of transmission from high to low.

The communication unit 710 may receive (or obtain via the cooperating device or the source device) a status report generated by a cooperating device or a source device. The present disclosure does not impose a limitation thereon. In addition, indexes used by the cooperating device or the source device to generate a status report may be, as described in the first embodiment, a first index D, that is, a distance between a cooperating device and a source device, a second index Q₀, that is, a quality of a signal received by a cooperating device from a source device, or a third index Q, that is, a quality of a signal received by a destination device through the cooperative transmission, and the like.

The determination unit 720 of the electronic device 700 may be configured to determine an adjustment to the cooperative transmission based on the received status report.

The optional generation unit 330 of the electronic device 700 may be configured to generate an adjustment notification instructing the adjustment to the cooperative transmission, and the communication unit 320 may be further configured to transmit the generated adjustment notification to the cooperating device and/or the source device.

In the above manner, when the electronic device 700 is used as a device for managing or adjusting a cooperative transmission, it may determine an adjustment to the cooperative transmission based on the received status report, and optionally generate an adjustment notification instructing the adjustment to the cooperative transmission, and transmit the generated adjustment notification to the cooperating device and/or the source device to implement the determined adjustment.

Next, consider an example in which the electronic device according to the second embodiment is dedicated to a destination device (for example, an aggregation server AS or a base station gNB as illustrated in FIG. 1A or FIG. 1B), that is, a second configuration example of the electronic device.

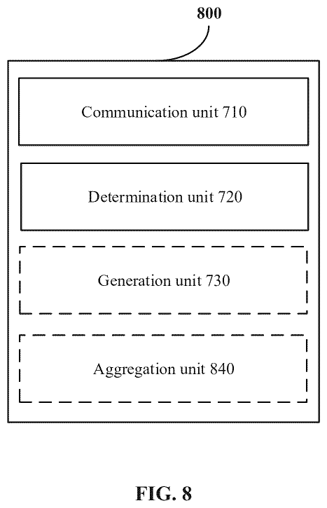

FIG. 8 is a block diagram illustrating a second configuration example of an electronic device 800 according to the second embodiment. As illustrated in FIG. 8, the electronic device 800 is different from the electronic device 700 according to the first configuration example in that an aggregation unit 840 for implementing aggregation of cooperative transmitted data is additionally included. The aggregation unit 840 may be configured to: receive, from a current cooperating device, a part of data originating from the source device and to be transmitted to the destination device; receive, from at least one other devices, other parts of data originating from the source device and to be transmitted to the destination device; and integrate the received parts of data originating from the source device.

Hereinafter, appropriate descriptions will be given, in combination with a case where the electronic device 700 or 800 according to the second embodiment is implemented on a destination-device (AS or gNB) side in a cooperative transmission system as illustrated in FIG. 1A or FIG. 1B, for further details of processing performed by respective units 710 to 730 in first or second configuration example described above; these details are similarly or analogously applicable to a case where the electronic device 700 is implemented on a source-device (UE0) side (differences therein will be described in detail in a subsequent section of modification examples, which will not be repeated here).

Examples/example processing related to the communication unit The communication unit 710 of the electronic device receives a status report from the cooperating device or the source device, and may be configured to: receive a first status report generated in a case where the transmission indicating index falls within the second range indicating medium quality of transmission; and/or receive a second status report generated in a case where the transmission indicating index falls within the third range indicating the lowest quality of transmission.

The first or second status report received by the communication unit 710 may, for example, have one bit to respectively indicate a first state (bit 0) of medium quality of transmission and a second state (bit 1) of the lowest quality of transmission.

Optionally, the following case exists: a cooperating device or a source device that generates and transmits a status report to the electronic device according to this embodiment may obtain multiple indexes, such as the above first index D, second index Q₀, or third index Q. In addition, the cooperating device or the source device may store multiple sets of corresponding index thresholds or index ranges, where each set of index thresholds is determined, for example, based on parameter thresholds of one of first to fourth parameters S, Q₀, Nᵣₑ, and Q, or each set of index ranges is divided using parameter thresholds (S1, S2; Q₀, Q₀2; Nᵣₑ1, Nᵣₑ2; or Q1, Q2) of one of first to fourth parameters S, Q₀, Nᵣₑ, and Q. As described in the first embodiment above, the first parameter S is a transmission rate between a cooperating device and a source device, the second parameter Q₀ is a quality of a signal received by a cooperating device from a source device, the third parameter Nᵣₑ is the number of retransmissions between a cooperating device and a source device, and the fourth parameter Q is a quality of a signal received by a destination device through a cooperative transmission. In this case, the cooperating device or the source device may generate a status report based on a comparison between one of the above first, second, and third indexes (D, Q₀, Q) obtained in real time and a corresponding pre-stored set of index thresholds or index ranges.

At this time, in addition to indication information regarding the first or second state (for example, a single bit 0 or 1), the status report received by the communication unit 710 may further include first additional information regarding a currently used index (for example, two bits indicating one of first to third indexes D, Q₀, and Q) and/or second additional information regarding a parameter used to divide a currently used index range (for example, two bits indicating one of first to fourth parameters S, Q₀, Nᵣₑ, and Q).

For example, the status report received by the communication unit 710 may have a form of a bit sequence of a length of 5, where, in addition to a first bit indicating the first or second state of quality of transmission, first and second additional information of 4 bits are further included to indicate further details of the current cooperative transmission. For example, the communication unit 710 may receive a first status report having a form such as or {00110}, which, in addition to a first bit (0) of a first state indicating quality of transmission, further uses a second and a third bit (00 or 01) to indicate a first or a second index (D or Q₀), and uses a fourth and a fifth bit (10) to indicate a third parameter (Nᵣₑ) used to divide a current index range.

### Examples/Example Processing Related to the Determination Unit and the Generation Unit

The determination unit 720 of the electronic device may determine an appropriate adjustment to a cooperative transmission based on the first or the second status report received by the communication unit 710, and a generation unit 730 may generate a corresponding adjustment notification and transmit it via the communication unit 710. Next, examples/example processing in respective application examples will be described in combination with specific application scenarios.

### First Application Example

Here, first consider a first application example related to the first status report, which is, for example, particularly suitable for example applications as illustrated in FIG. 1B.

For example, in this application example, the electronic device 800 according to this embodiment serving as a cooperation management device may be a network-side device, for example, a base-station-side device gNB, communication between a source device and a cooperating device may be performed via a sidelink (Sidelink), and the electronic device 800 such as the gNB may allocate communication resources for Sidelink communication.

In one example, at this time, the first status report received by the communication unit 710 may, in addition to indicating a first state to indicate medium quality of transmission, also indicate, via first and second additional information, a second or third index currently used (D or Q₀) and a third parameter (the number Nᵣₑ of retransmissions between the source device and the cooperating device) used to divide a current index range. In another example, the first status report received by the communication unit 710 may, in addition to indicating first state, also indicate, via first and second additional information, a second index (Q₀) currently used and a second parameter (a quality Q₀ of a signal received by a cooperating device from a source device) used to divide a current index range. The above first status report may, for example, have a form of a bit sequence such as {00010} or {00110}.

In the above two example cases, the determination unit 720 of the electronic device that receives the first status report may determine, based on the first status report, to adjust resources allocated for the current sidelink communication between the current cooperating device and the source device (a first adjustment).

Here, the first adjustment may include: increasing feedback resources allocated to the current cooperating device for the current sidelink communication (a feedback resource adjustment); and/or switching frequency resources allocated for the current sidelink communication from a first frequency band to a second frequency band lower than the first frequency band (a frequency-band adjustment). Whether to make the first adjustment specifically for feedback resources or for the frequency band may be specifically determined by another electronic device, for example, based on the second additional information included in the received first status report. That is, when the second additional information indicates the third parameter as the number Nᵣₑ of retransmissions, the first adjustment is implemented as the feedback resource adjustment, and when the second additional information indicates the second parameter as the reception signal quality Q₀, the first adjustment is implemented as the frequency-band adjustment.

In addition, optionally, in the above two example cases, the generation unit 730 may generate a first adjustment notification instructing a corresponding adjustment, the notification instructing an adjustment to communication resources allocated for the current sidelink communication between the current cooperating device and the source device. For example, the first adjustment notification may correspondingly instruct an allocation of increased feedback resources for the current sidelink communication to the current cooperating device, or instruct an allocation of frequency resources in a second frequency band (for example, an FR1 band) lower than a first frequency band (for example, an FR2 band) currently used for the current sidelink communication.

Here, the first adjustment notification may have various appropriate forms. For example, it may be configuration information of a base-station-side device for reconfiguration of the sidelink communication or a dynamic DCI indication. The present disclosure does not impose a limitation thereon.

More specifically, periodic feedback resources allocated or adjusted by an electronic device 800 such as a gNB for Sidelink communication between UEi and UE0 may be indicated via, for example, configuration information generated by the generation unit 730 (for example, a parameter indicating a period of feedback resources in a configured resource pool) or DCI. The generation unit 730 may generate configuration information indicating modified feedback resources (a feedback resource period), or generate DCI indicating a switch to a shorter feedback resource period in real time when there are multiple configurations regarding feedback resources (a feedback resource period) and the like, to generate a first adjustment notification instructing the allocation of increased feedback resources. Similarly, a first adjustment notification instructing the switching of frequency resources such as from a first frequency band to a second frequency band may also be implemented by the generation unit 730 generating configuration information indicating modified frequency resources, or generating DCI indicating a switch to a lower second frequency band in real time when there are multiple frequency resource configurations.

The communication unit 710 may transmit the first adjustment notification generated by the generation unit 730 to a cooperating device or a source device.

A current cooperating device or a source device that receives the above first adjustment notification may use the adjusted communication resources to continue current sidelink communication between the current cooperating device and the source device so as to improve a communication quality. For example, the cooperating device or the source device may use increased feedback resources, allocated for the current sidelink communication by the adjustment notification, to perform transmission of HARQ requests between the cooperating device and the source device, so as to meet a demand of a larger number of HARQ requests; or the cooperating device or the source device may switch to a second frequency band (for example, an FR1 band), allocated by the adjustment notification for the current sidelink communication, lower than a first frequency band (for example, an FR2 band) currently used to perform the current sidelink communication, and optionally switch beam communication of a higher frequency band to omnidirectional communication of a lower frequency band, so as to avoid continuing to apply an unsuitable high frequency band and/or beam communication to the current sidelink.

In this manner, the quality of current sidelink communication between the current cooperating device and the source device can be improved, thereby favoring improvement of the quality of transmission of the cooperative transmission.

### Second Application Example

Next, a second application example related to a second status report, which is suitable for example applications as illustrated in both FIG. 1A and FIG. 1B, will be described.

In this application example, the electronic device 800 of this embodiment serving as a cooperation management device may be a network-side device, for example, an aggregation server AS or a base-station-side device gNB.

In one example, at this time, the second status report received by the communication unit 710 from a cooperating device or a source device may indicate a second state using only one bit (1), so as to indicate that the quality of transmission of the cooperative transmission via the current cooperating device UEi deteriorates severely. Accordingly, the determination unit 720 of the electronic device that receives the second status report may determine, based on the second status report, to cause the current cooperating device to exit the cooperative transmission (a second adjustment). Optionally, the generation unit 730 may generate a second adjustment notification instructing the adjustment, and the communication unit 710 may transmit the second adjustment notification generated by the generation unit 730 to the cooperating device or the source device to instruct the current cooperating device to exit the cooperative transmission.

A current cooperating device or a source device that receives the above second adjustment notification may determine to terminate current sidelink communication between the current cooperating device and the source device, and thus cause the current cooperating device to exit the cooperative transmission. In this manner, it is possible to prevent a current cooperating device that is unsuitable from continuing to retain in the cooperative transmission system and causing a decrease in quality of transmission.

### Third Application Example

Next, a third application example related to a first and/or a second status report, which is suitable for both example applications illustrated in FIG. 1A and FIG. 1B, will be described.

In this application example, an electronic device 800 according to this embodiment serving as a cooperation management device may be a network-side device, for example, an aggregation server AS or a base-station-side device gNB.

In one example, at this time, the first status report received by the communication unit 710 may only indicate a first state to indicate medium quality of transmission, and may optionally also indicate, via first and second additional information, one among first to third indexes (D, Q₀, Q) currently used and one among first to fourth parameters (a transmission rate S between a cooperating device and a source device, a quality Q₀ of a signal received by a cooperating device from a source device, the number Nᵣₑ of retransmissions between a source device and a cooperating device, a quality Q of a signal received by a destination device through a cooperative transmission) used to divide a current index range.

In addition, for example, at this time, the second status report received by the communication unit 710 may only indicate a second state, and may also include first and/or second additional information indicating further details. This is not limited herein.

In this case, the determination unit 720 of the electronic device that receives the first status report may determine, based on the first and/or second status report, an additional adjustment to the cooperative transmission system that is different from the above first or second adjustment. The term “additional adjustment” indicates that the adjustment involves other cooperating device other than the current cooperating device or newly added cooperating device. More specifically, the determined additional adjustment may include, for example but not limited to, increasing a transmission amount and/or a transmission rate of one or more other cooperating devices in the cooperative transmission (a first additional adjustment), and/or adding a new cooperating device to the cooperative transmission (a second additional adjustment), and the like. In a preferred example, the determination unit 720 may determine the first additional adjustment based on the first status report, and determine the second additional adjustment based on the second status report.

In addition, optionally, in a case where the determination unit 720 determines the above first and/or second additional adjustment, the generation unit 730 may generate a first and/or a second additional adjustment notification instructing a corresponding adjustment. For example, the first additional adjustment notification may make one or more instructions as follows: instruct the source device to perform data transmission to a further cooperating device with an increased transmission amount; instruct the other cooperating device to perform transmission to a destination device at a higher uplink rate; and/or instruct both the source device and the other cooperating device to perform transmission between the two (such as Sidelink transmission) at an increased transmission rate, thereby increasing the transmission amount and/or the transmission rate of the cooperating device in the cooperative transmission. In addition, the second additional adjustment notification may instruct, for example, the source device to establish communication (such as Sidelink communication) with a new cooperating device, and perform a cooperative transmission via the new cooperating device.

The communication unit 710 may transmit the first and/or second additional adjustment notification generated by the generation unit 730 to the source device and cooperating devices involved. That is, the communication unit 710 may transmit the first additional adjustment notification to the source device and the other cooperating device indicated by the instruction of the notification, and/or transmit the second additional adjustment notification to the source device and the new cooperating device indicated by the instruction of the notification. Accordingly, respective devices that receive the above additional adjustment notification may make a corresponding adjustment according to an instruction of the adjustment notification, so as to increase a transmission amount and/or a transmission rate of one or more other cooperating devices in the cooperative transmission and/or add a new cooperating device to the cooperative transmission.

In this manner, the cooperative transmission can be improved by using other or newly added cooperating device, thereby favoring improvement of the quality of transmission of the cooperative transmission.

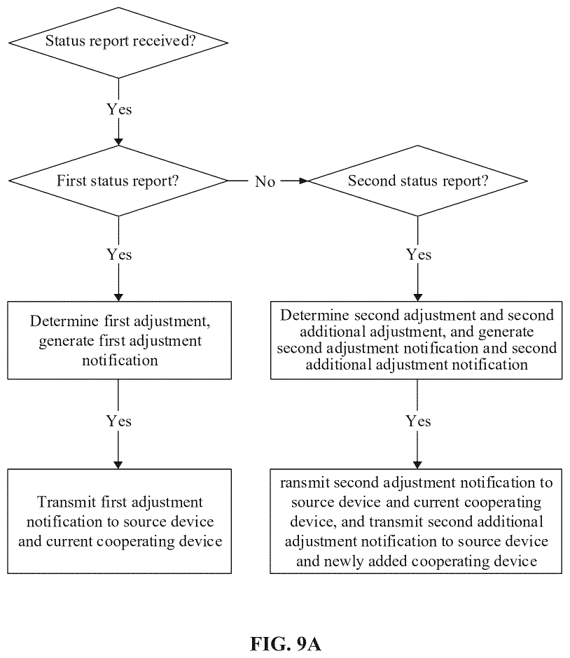

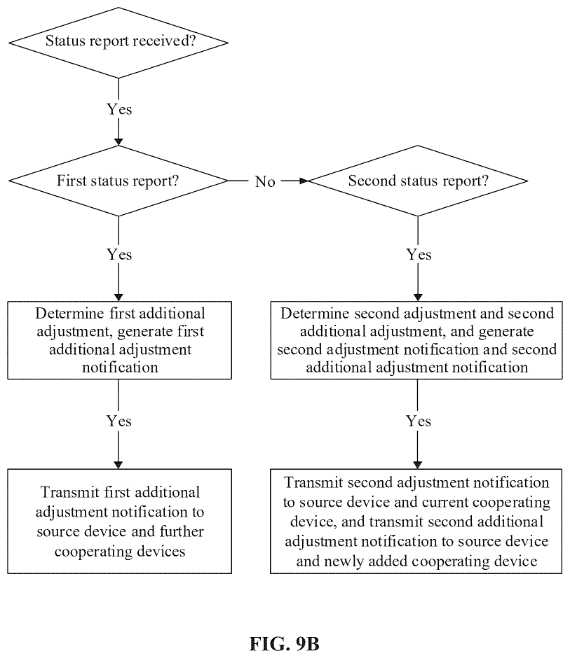

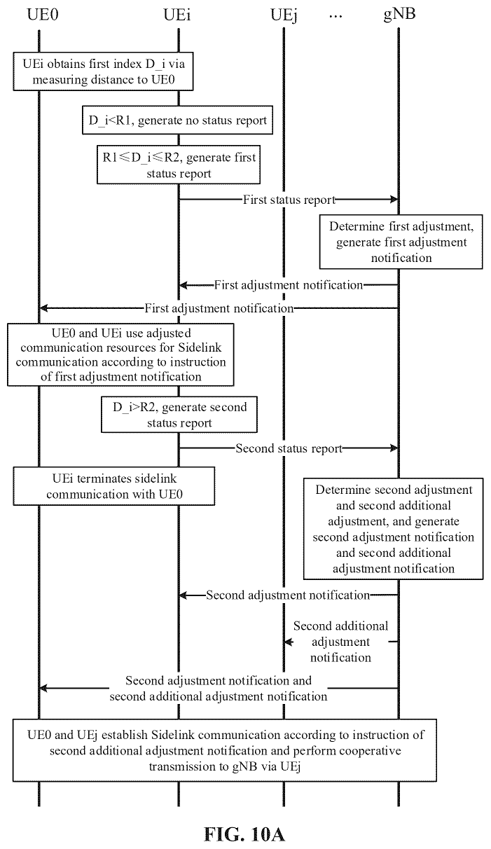

Note that example processing of the electronic device (respective units 710 to 730) described in the third application example above may be applied alone, or may be applied in combination with the foregoing first and/or second application example. Here, example processing performed by the electronic device 700 or 800 in two possible combinations is briefly described with reference to FIGS. 9A to 9B.

FIG. 9A illustrates example processing of a first combination of the first application example to the third application example, which is, for example, suitable for an example scenario as illustrated in FIG. 1B.

As illustrated in FIG. 9A, in this example, upon receiving a status report, the electronic device may use its determination unit 720 to determine only a first adjustment based on a first status report so as to adjust communication resources allocated for communication such as sidelink communication between a source device and a cooperating device, and may, based on a second status report, simultaneously determine a second adjustment and a second additional adjustment (and optionally a first additional adjustment) so as to cause a current cooperating device to exit the cooperative transmission and cause a new cooperating device to be added to the cooperative transmission. Meanwhile, the electronic device may use its generation unit 730 to generate a first adjustment notification based on the determined adjustment, or generate a second adjustment notification and a second additional adjustment notification (and optionally a first additional adjustment notification). Thereafter, the electronic device may use its communication unit 710 to transmit the generated adjustment notification to the source device and a corresponding cooperating device.

FIG. 9B illustrates example processing of a second combination of the first application example to the third application example, which may be suitable for example scenarios illustrated in FIG. 1A and FIG. 1B.

As illustrated in FIG. 9B, in this example, upon receiving a status report, the electronic device may use its determination unit 720 to determine only a first additional adjustment (and optionally a second additional adjustment) based on a first status report so as to increase a transmission amount/transmission rate of a further cooperating device, and may, based on a second status report, simultaneously determine a second adjustment and a second additional adjustment (and optionally a first additional adjustment) so as to cause a current cooperating device to exit the cooperative transmission and cause a new cooperating device to be added to the cooperative transmission. Meanwhile, the electronic device may use its generation unit 730 to generate a first adjustment notification (and optionally a second additional adjustment adjustment) based on the determined adjustment, or generate a second adjustment notification and a second additional adjustment notification (and optionally a first additional adjustment notification). Thereafter, the electronic device may use its communication unit 710 to transmit the generated adjustment notification to the source device and a corresponding cooperating device.

Combinations of the above first application example to third application example are given merely as examples. The present disclosure does not impose a limitation on specific combination manners, which will not be repeated here.

### 3.2 Example Signaling Interactions

The electronic device 300 according to the first embodiment for generating and transmitting a status report to another electronic device and the electronic device 700 or 800 in first and second configuration examples according to the second embodiment for determining an adjustment to the cooperative transmission based on the received status report have been described above.

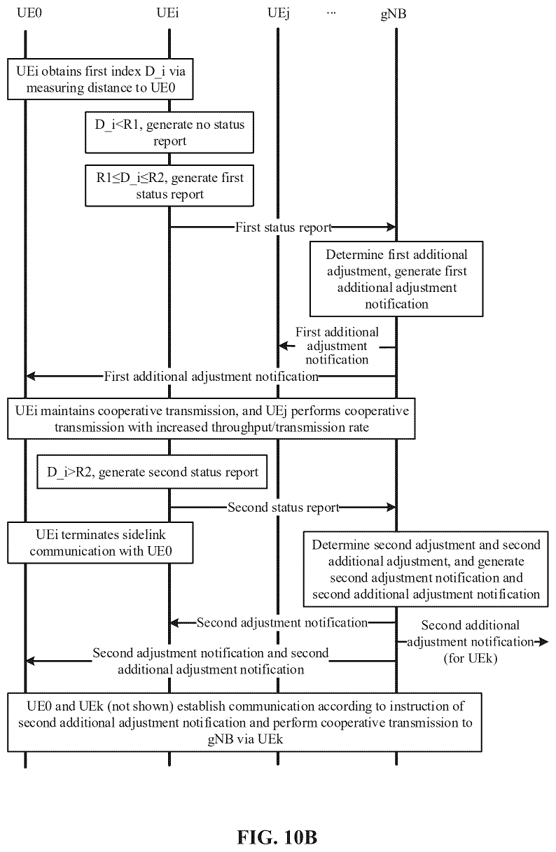

Next, in combination with example processing performed by the electronic device according to the second embodiment described above with reference to FIGS. 9A and 9B, example signaling interactions implemented by an electronic device 300 implemented on a cooperative-device UEi side and an electronic device 800 implemented on a destination-device (AS or gNB) side will be described with reference to FIGS. 10A and 10B. In examples of FIG. 10A or FIG. 10B, the cooperating device UEi may have the configuration of the electronic device 300 according to the first embodiment, a base-station-side device gNB or an aggregation server AS as a destination device may have the configuration of the electronic device 800 according to the second embodiment, and UEj or UEk is a further or newly added cooperating device.

First, reference is made to FIG. 10A which, on a basis of the example described in FIG. 9A, illustrates example signaling interactions which are, for example, suitable for an example scenario as illustrated in FIG. 1B.

As illustrated in FIG. 10A, in this example, the cooperating device UEi may obtain a first index D_i, for example, by measuring a distance to a source device UE0, and, depending on a comparison between the index and first to third ranges (D_i<R1, R1≤D_i≤R2, or RD_i>R2) divided based on distance index thresholds R1 and R2, generate no status report, generate a first status report, or generate a second status report. In addition, in a case where D_i falls within the third range (RD_i>R2), UEi may directly terminate sidelink communication with UE0 and thus exit the cooperative transmission. Here, for example, the first status report may have a form of a bit sequence described previously, for example or {00010}, to indicate a first state (0), a first index D (00) currently used, and a second parameter Q₀ as a reception signal quality (01) or a third parameter Nᵣₑ as the number of retransmissions (10) used to divide a current index range. The second status report may have a form of a single bit (1).

UEi may transmit the generated first or second status report to a destination device (a cooperation management device) gNB. Accordingly, the gNB that receives the first status report may determine a first adjustment to adjust communication resources allocated for the communication such as sidelink communication between the source device UE0 and the cooperating device UEi, and generate a first adjustment notification instructing the adjustment.

For example, in a case of receiving a first status report in the form of {00001}, the gNB may understand that a second parameter Q₀ as a reception signal quality is used to divide a current index range, and accordingly determine a first adjustment for adjusting a frequency band of Sidelink communication (switching from a first frequency band to a lower second channel) and generate an adjustment notification instructing the adjustment. In a case of receiving a first status report in the form of {00010}, the gNB may understand that a third parameter Nᵣₑ as the number of retransmissions is used to divide a current index range, and accordingly determine a first adjustment for adjusting feedback resources and generate an adjustment notification instructing the adjustment.

The gNB may transmit the above first adjustment notification to UE0 and UEi.

UE0 and UEi that receive the first adjustment notification may perform Sidelink communication using the adjusted communication resources (for example, the adjusted feedback resources or frequency bands) according to an instruction of the notification.

In addition, the gNB that receives the second status report may determine a second adjustment and a second additional adjustment so as to cause the current cooperating device UEi to exit the cooperative transmission and cause a new cooperating device UEj to be added to the cooperative transmission, and generate a second adjustment notification and a second additional adjustment notification that respectively instruct the above adjustments. The gNB may transmit the above second adjustment notification to UE0 and UEi, and transmit the above second additional adjustment notification to UE0 and UEj.

The source device UE0 that receives the second adjustment notification may, for example, confirm that UEi exits the cooperative transmission and no longer attempt to transmit data to the latter, and the like. In addition, the source device UE0 and a new cooperating device UEj that receive the second additional adjustment notification may establish Sidelink communication and perform cooperative transmission to the gNB via UEj according to an instruction of the notification.

Note that, for simplicity of illustration, only one acquisition processing of acquiring the first index is illustrated in FIG. 10A and subsequent acquisition processing is omitted, but the acquisition processing may be performed periodically, for example, and a range in which the first index obtained falls within may correspond to different ranges in three graphs such as those in FIG. 5. In addition, although the first index is illustrated as an example in FIG. 10A, it is not limited thereto, but may be, for example, the second index. In addition, although it is illustrated in the figure that the gNB directly transmits an adjustment notification to cooperating devices UEi and UEj and the like, the transmitting may be implemented via forwarding by the UE0, which will not be elaborated here.

Next, reference is made to FIG. 10B which, on a basis of the example described in FIG. 9B, illustrates example signaling interactions which are, for example, suitable for example scenarios as illustrated in FIG. 1A and FIG. 1B.

As illustrated in FIG. 10B, in this example, the cooperating device UEi obtains a first index D_i in a manner similar to that of FIG. 9A, and, depending on a comparison between the index and first to third ranges (D_i<R1, R1≤D_i≤R2, or RD_i>R2) divided based on distance index thresholds R1 and R2 and the like, generate no status report, generate a first status report, or generate a second status report. In addition, in a case where D_i falls within the third range (RD_i>R2), UEi may directly terminate direct communication with UE0 and thus exit the cooperative transmission. Here, both first and second status reports may simply have a form of a single bit.

UEi may transmit the generated first or second status report to the gNB.

Accordingly, an AS that receives the first status report may determine a first additional adjustment to increase a transmission amount/transmission rate of a further cooperating device UEj, and generate a first additional adjustment notification instructing the adjustment. The gNB may transmit the above first additional adjustment notification to UE0 and UEj.

In this case, UEi may maintain its cooperative transmission without making any adjustments. UE0 and UEj that receive the first additional adjustment notification may cause UEj to perform cooperative transmission with an increased transmission amount/transmission rate according to an instruction of the notification.

In addition, the gNB that receives the second status report may determine a second adjustment and a second additional adjustment so as to cause the current cooperating device to exit the cooperative transmission and cause a new cooperating device UEk (not illustrated in the figure) to be added to the cooperative transmission, and generate a second adjustment notification and a second additional adjustment notification that respectively instruct the above adjustments. The gNB may transmit the above second adjustment notification to UE0 and UEi, and transmit the above second additional adjustment notification to UE0 and a newly added cooperating device UEk.

UE0 that receives the second adjustment notification may, for example, confirm that UE exits the cooperative transmission and no longer attempt to transmit data to the latter, and the like. In addition, UE0 and the newly added cooperating device UEk that receive the second additional adjustment notification may establish direct communication and perform cooperative transmission to the gNB via UEk according to an instruction of the notification.

Note that, for simplicity of illustration, only one acquisition processing of acquiring the first index is illustrated in FIG. 10B and subsequent acquisition processing is omitted, but the acquisition processing may be performed periodically, for example, and a range in which first index obtained falls within may correspond to different ranges in three graphs such as those in FIG. 5. In addition, although the first index is illustrated as an example in the figure, it is not limited thereto, but may be, for example, the second or third index. In addition, although it is illustrated in the figure that the gNB directly transmits an adjustment notification to cooperating devices UEi, UEj, UEk and the like, the transmitting may be implemented via forwarding by the UE0, which will not be elaborated here.

In addition, the example signaling flows in which the electronic devices according to the first and second embodiments interact with each other described above with reference to FIGS. 10A and 10B are merely example situations given for ease of understanding. Signaling flows of the present disclosure are not limited thereto, which will not be elaborated here.

### 3.3 Modification Examples

On the basis of the configuration example of the electronic device 700 according to the second embodiment described above, those skilled in the art can understand that various appropriate modifications may be made.

For example, the configuration examples of the electronic device 700 or 800 according to the second embodiment described above mainly take a case where the electronic device is applied to a destination device (an aggregation server AS or a base-station-side device gNB as in FIG. 1A or FIG. 1B) as an example, but those skilled in the art can understand from the above description that a modification example in which the electronic device 700 is similarly or analogously applied to a source device (UE0 as in FIG. 1A or FIG. 1B) can be obtained via appropriate modifications and/or variants.

For example, at this time, the communication unit 710 of the electronic device 700 on the UE0 side may receive a status report generated by a current cooperating device UEi, and transmit an adjustment notification generated by the generation unit 730 to corresponding cooperating devices (a current cooperating device, a further cooperating device, a newly added cooperating device, and the like) via communication such as sidelink communication between the cooperating device involved, which will not be elaborated here. In addition, it can be understood that at this time the electronic device 700 is used on a source-device UE0 side, and thus any adjustment notification transmitted to the source device may be omitted.

The first embodiment, in which a status report is generated depending on a relationship between a quality indication index and index ranges and transmitted to another electronic device, and the second embodiment, in which an adjustment to a cooperative transmission is determined based on a received status report, have been described above. On the basis of the above first and second embodiments, a third embodiment is also proposed, in which processing of generating and transmitting or receiving a status report in the first and second embodiments are omitted, and an adjustment to the cooperative transmission is directly determined depending on a relationship between a quality indication index and index ranges. Hereinafter, on a basis of the description of the first and second embodiments, an outline description of the third embodiment will be given, and unnecessary details thereof are omitted.

### 4. Configuration Examples of an Electronic Device According to a Third Embodiment

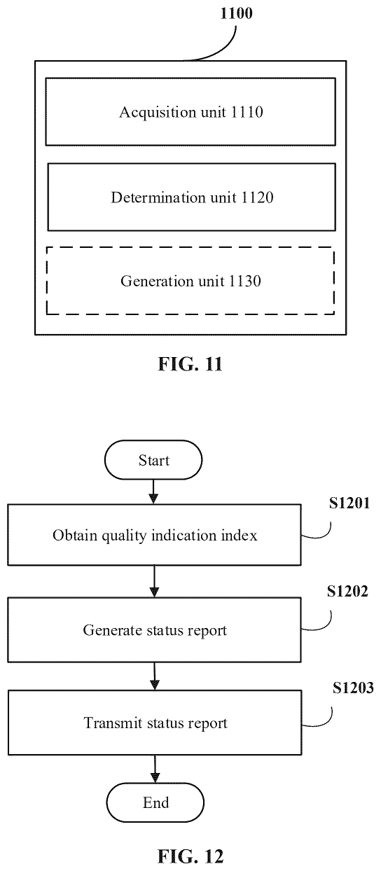

FIG. 11 is a block diagram illustrating a first configuration example of an electronic device according to a third embodiment of the present disclosure.

As illustrated in FIG. 11, an electronic device 1100 may include an acquisition unit 1110 and a determination unit 1120, and may further include an optional generation unit 1130. In addition, although not illustrated in the figure, the electronic device 1100 may further include: an optional communication unit for communication with other devices; and an optional storage unit for storing various programs, data, parameters, and the like.

Here, each unit of the electronic device 1100 may be included in a processing circuit. It should be noted that the electronic device 1100 may include one processing circuit or may include multiple processing circuits. Further, the processing circuit may include various discrete functional units to perform various different functions and/or operations. It should be noted that these functional units may be physical entities or logical entities, and units with different appellations may be implemented by the same physical entity.

The electronic device 1100 according to the third embodiment may be a network-side device or a terminal-side device, and may be used as a destination device or a source device in the cooperative transmission of FIG. 1A or FIG. 1B. The present disclosure does not impose a limitation thereon.

The acquisition unit 1110 of the electronic device 1100 may be configured to obtain an index (a quality indication index) regarding a quality of a cooperative transmission implemented by a current cooperating device, the cooperating device relaying a part of data originating from a source device and to be transmitted to a destination device to implement the cooperative transmission.

In other words, the acquisition unit 1110 of the electronic device 1100 has a function of obtaining a quality indication index similar to that of the acquisition unit 310 according to the first embodiment. Therefore, various descriptions regarding the acquisition unit 310 according to the first embodiment above may be similarly applicable to the acquisition unit 1110 of this embodiment. For example, the acquisition unit 1100 may obtain related indexes via necessary measurements or necessary communication with related devices, which will not be elaborated here.

In addition, the determination unit 1120 of the electronic device 1100 may be configured to: determine, depending on a relationship between the index and first to third ranges (index ranges) which sequentially indicate the quality of transmission from high to low, an adjustment to the cooperative transmission.

In other words, the acquisition unit 1120 of the device 1100 partially combines functions of the generation unit 320 of the electronic device 300 according to the first embodiment and the determination unit 720 of the electronic device 700 or 800 according to the second embodiment, so as to directly determine, based on the comparison between the quality indication index and the index ranges, no adjustment to the cooperative transmission is needed (a case where the index falls within the first range), a first or a second adjustment to the cooperative transmission is needed (a case where the index falls within the second or third range), and/or a first or a second additional adjustment to the cooperative transmission is needed (a case where the index falls within the second or third range). Various descriptions regarding the generation unit 320 according to the first embodiment or the determination unit 720 of the second embodiment above may be similarly applicable to the acquisition unit 1120 of the electronic device according to this embodiment, which will not be repeated here.

In addition, optionally, in addition, the generation unit 1130 of the electronic device 1100 may be configured to: generate an adjustment notification regarding the determined adjustment to the cooperative transmission, so as to instruct the determined adjustment to the cooperative transmission.

In other words, the generation unit 1130 of the electronic device 1100 partially combines functions of the generation unit 730 of the electronic device 700 or 800 according to the second embodiment, and may, for example, correspondingly generate a first or a second adjustment notification and/or a first or a second additional adjustment notification based on the determined first or second adjustment to the cooperative transmission and/or first or second additional adjustment to the cooperative transmission. Various descriptions regarding the generation unit 730 of the second embodiment above may be similarly applicable to the generation unit 1130 of the electronic device according to this embodiment, which will not be repeated here.

In addition, the communication unit (not illustrated) of the electronic device 1100 may transmit an adjustment notification generated by the generation unit 1230 to a corresponding device so as to implement the determined adjustment. In other words, the communication unit of the electronic device 1100 may have a function similar to that of a communication unit 710 of the electronic device 700 or 800 according to the second embodiment in terms of transmitting an adjustment notification. For example, in a case where the electronic device 1100 is implemented on a source-device side, its communication unit may transmit an adjustment notification to a corresponding cooperating device involved; and in a case where the electronic device 1100 is implemented on a destination-device side, its communication unit may transmit an adjustment notification to a source device and a corresponding cooperating device involved. Various descriptions regarding the communication unit 710 according to the second embodiment above may be similarly applicable to the communication unit of the electronic device according to this embodiment, which will not be repeated here.

### 5. Method Embodiments

FIG. 12 is a flowchart illustrating a process example of a communication method according to a first embodiment of the present disclosure.

As illustrated in FIG. 12, in step S1201, an index (a quality indication index) regarding a quality of a cooperative transmission implemented by a current cooperating device is obtained, the cooperating device relaying a part of data originating from a source device and to be transmitted to a destination device to implement the cooperative transmission.

Next, in step S1202, depending on a relationship between the index and first to third ranges which sequentially indicate the quality of transmission from high to low, a status report about the current cooperating device is generated.

Next, in step S1203, the generated status report is transmitted to another electronic device.

As an example, the index obtained in step S1201 may indicate one or more of: a distance between the cooperating device and the source device; a quality of a signal received by the cooperating device from the source device; or a quality of a signal received by the destination device through the cooperative transmission.

In one example, the index indicating the quality of the signal received by the destination device through the cooperative transmission may be determined based on one or more of: a probability of packet retransmission between the source device and the cooperating device; a probability of packet retransmission between the cooperating device and the destination device; and a transmission delay between the cooperating device and the destination device.

In addition, as an example, the first range, the second range, and the third range used in step S1201 may be divided based on a first threshold and a second threshold of the index determined based on the following thresholds: a first threshold and a second threshold of a transmission rate between the cooperating device and the source device; a first threshold and a second threshold of a quality of a signal received by the cooperating device from the source device; a first threshold and second threshold of the number of retransmissions between the cooperating device and the source device; and/or a first threshold and second threshold of a quality of a signal received by the destination device through the cooperative transmission.

Optionally, the example method illustrated in FIG. 12 may be executed on a source-device side or a cooperative-device side.

In the method illustrated in FIG. 12, in a case where the index falls within the first range indicating the highest quality of transmission, no status report is generated in step S1202. In addition, in step S1202, the following processing may be performed: in a case where the index falls within the second range indicating medium quality of transmission, a first status report is generated; and/or in a case where the index falls within the third range indicating the lowest quality of transmission, communication between the cooperating device and the source device is terminated, and a second status report is generated.

In addition, optionally, although not illustrated in the figure, the method may further include the following processing: receiving an adjustment notification generated by another electronic device based on the received status report, the adjustment notification instructing an adjustment to the cooperative transmission; and optionally performing the adjusted cooperative transmission according to the instruction of the adjustment notification.

For example, in one example, a first adjustment notification generated by said another electronic device based on the first status report may be received, the notification instructing an adjustment to communication resources allocated for a current sidelink communication between the current cooperating device and the source device.

For example, a first adjustment notification instructs an allocation of increased feedback resources for the current sidelink communication to the current cooperating device, or instructs an allocation of frequency resources in a second frequency band lower than a first frequency band currently in use for the current sidelink communication.

In another example, a second adjustment notification generated by another electronic device based on the second status report may be received, the notification instructing the current cooperating device to exit the cooperative transmission.

According to an embodiment of the present disclosure, a subject that executes the above method may be the electronic device according to the first embodiment of the present disclosure, and therefore all the embodiments of the electronic device according to the first embodiment described above are applicable thereto.

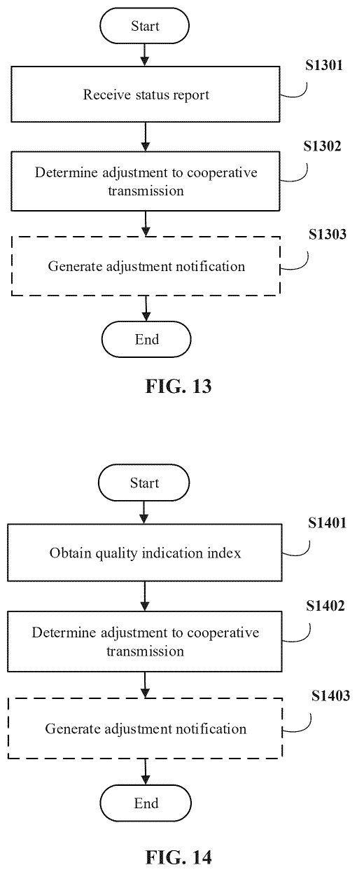

FIG. 13 is a flowchart illustrating a process example of a communication method according to a second embodiment of the present disclosure.

As illustrated in FIG. 13, in step S1301, a status report about a current cooperating device is received, the cooperating device relaying a part of data originating from a source device and to be transmitted to a destination device to implement a cooperative transmission.

Next, in step S1302, an adjustment to the cooperative transmission is determined based on the received status report.

Next, in optional step S1303, an adjustment notification instructing the adjustment to the cooperative transmission is generated. In addition, although not illustrated, the method may further include: transmitting the generated adjustment notification to the cooperating device and/or the source device.

As an example, in step S1301, the status report may be received from the cooperating device or the source device.

For example, in step S1301, a first status report generated in a case where the index falls within the second range indicating medium quality of transmission may be received; and/or a second status report generated in a case where the index falls within the third range indicating the lowest quality of transmission may be received.

Accordingly, in step S1302, it may be determined to increase the transmission amount and/or the transmission rate of one or more other cooperating devices in the cooperative transmission, and/or to add a new cooperating device to the cooperative transmission based on the first or second status report.

For example, in one example, in step S1302, it may be determined to adjust the resources allocated for the current sidelink communication between the current cooperating device and the source device based on the first status report.

For example, in this step, feedback resources allocated to the current cooperating device for the current sidelink communication may be increased; and/or frequency resources allocated for the current sidelink communication may be switched from a first frequency band to a second frequency band lower than the first frequency band.

In another example, in step S1302, it may be determined to cause the current cooperating device to exit the cooperative transmission based on the second status report.

Optionally, the method of FIG. 13 may be executed on a destination-device side.

In this case, optionally, although not illustrated in the figure, the method may further include the following processing: receiving, from the current cooperating device, a part of data originating from the source device and to be transmitted to the destination device; receiving, from at least one of other device, other parts of data originating from the source device and to be transmitted to the destination device; and integrating the received parts of data originating from the source device.

According to an embodiment of the present disclosure, a subject that executes the above method may be the electronic device according to the second embodiment of the present disclosure, and therefore all the embodiments of the electronic device according to the second embodiment described above are applicable thereto.

FIG. 14 is a flowchart illustrating a process example of a communication method according to a third embodiment of the present disclosure.

As illustrated in FIG. 14, in step S1401, an index (a quality indication index) regarding a quality of a cooperative transmission implemented by a current cooperating device is obtained, the cooperating device relaying a part of data originating from a source device and to be transmitted to a destination device to implement the cooperative transmission.

Next, in step S1402, depending on a relationship between the index and first to third ranges that respectively indicate qualities of transmission from high to low, an adjustment to the cooperative transmission is determined.

Next, in an optional step S1403, an adjustment notification instructing the adjustment to the cooperative transmission is generated. In addition, although not illustrated, the method may further include: transmitting the generated adjustment notification to the cooperating device and/or the source device.

According to an embodiment of the present disclosure, a subject that executes the above method may be the electronic device according to the third embodiment of the present disclosure, and therefore all the embodiments of the electronic device according to the third embodiment described above are applicable thereto.

### 6. Application Examples

The technology of the present disclosure may be applied to various products.

For example, the electronic devices of the second embodiment and the third embodiment, when used for a destination device (a cooperation management device), may be server devices. The electronic device may be implemented as any type of control entity, such as various types of servers, such as a tower server, a rack server, and a blade server. The electronic device may be a control module installed on a server (such as an integrated circuit module including a single chip, and a card or a blade inserted into a slot of a blade server).

In addition, the electronic devices of the second embodiment and the third embodiment, when used for a destination device (a cooperation management device), may also be implemented on a base-station side. When the electronic device is implemented on the base-station side, the electronic device may be implemented as any type of base-station equipment, such as a macro eNB and a small eNB, and may also be implemented as any type of gNB (a base station in a 5G system). The small eNB may be an eNB that covers a cell smaller than a macro cell, such as a pico eNB, a micro eNB, and a home (femto) eNB. Alternatively, the base station may be implemented as any other type of base station, such as a NodeB and a base transceiver station (BTS). The base station may include: a body (which is also referred to as a base-station device) configured to control wireless communication; and one or more remote radio heads (RRHs) arranged in a different place from the body.

The electronic device on the base-station side may also be implemented as any type of TRP. The TRP may have transmitting and receiving functions, such as receiving information from a user equipment and a base-station device and transmitting information to a user equipment and a base-station device. In a typical example, the TRP may provide services to a user equipment and be controlled by a base-station device. Furthermore, the TRP may have a structure similar to the structure of the base-station device, or may only have a structure related to transmitting and receiving information in the base-station device.

In addition, the electronic devices of the first embodiment to the third embodiment may all be implemented on a terminal side (as a source device, a cooperating device, or a destination device). When the electronic device is implemented on the terminal side, for example implemented as a terminal device, the electronic device may be various types of user equipment, which may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may also be implemented as a terminal (also referred to as a machine type communication (MTC) terminal) that performs machine-to-machine (M2M) communication. In addition, the user equipment may be a wireless communication module (such as an integrated circuit module including a single chip) installed on each of the above user equipment.

### Application Examples of Control Entities

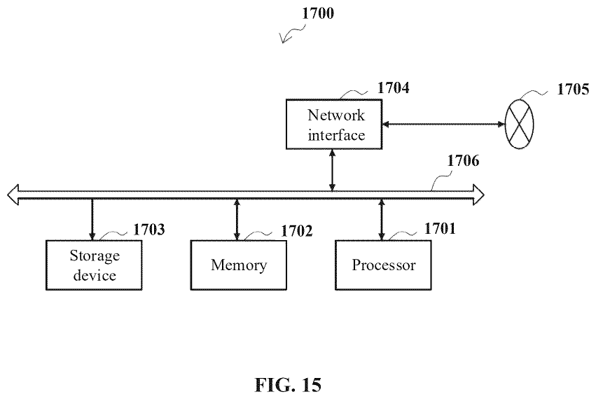

FIG. 15 is a block diagram illustrating an example of a schematic configuration of a server 1700 to which the technology of the present disclosure may be applied. The server 1700 includes a processor 1701, a memory 1702, a storage device 1703, a network interface 1704, and a bus 1706.

The processor 1701 may be, for example, a central processing unit (CPU) or a digital signal processor (DSP), and controls functions of the server 1700. The memory 1702 includes a random access memory (RAM) and a read only memory (ROM), and stores data and programs executed by the processor 1701. The storage device 1703 may include a storage medium, such as a semiconductor memory and a hard disk.

The network interface 1704 is a wired communication interface for connecting the server 1700 to a wired communication network 1705. The wired communication network 1705 may be a core network such as an evolved packet core (EPC) or a packet data network (PDN) such as the internet.

The bus 1706 connects the processor 1701, the memory 1702, the storage device 1703, and the network interface 1704 to each other. The bus 1706 may include two or more buses each having a different speed (such as a high-speed bus and a low-speed bus).

In the server 1700 illustrated in FIG. 15, at least part of functions of the determination unit, the generation unit, and the aggregation unit in the electronic device 700 or 800 described above with reference to FIG. 7 or FIG. 8, and functions of the acquisition unit, the determination unit, and the generation unit of the electronic device 1100 described with reference to FIG. 11 may be implemented by the processor 1701. For example, the processor 1701 may implement functions of the above units by executing instructions stored in the memory 1702 or the storage device 1703. In addition, communication units (possibly not shown) of these electronic devices may be implemented via the network interface 1704 and the like. In addition, storage units (not shown) of these electronic devices may be implemented by the memory 1702 and/or the storage device 1703.

### Application Examples of a Base Station

### First Application Example

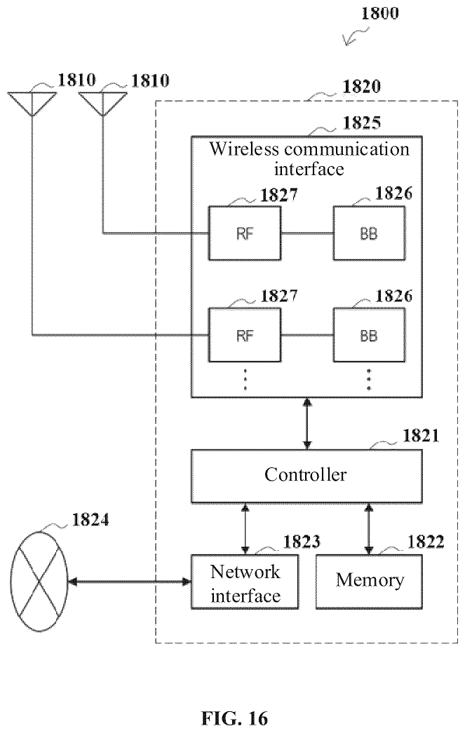

FIG. 16 is a block diagram illustrating a first example of a schematic configuration of an eNB to which the technology of the present disclosure may be applied. An eNB 1800 includes one or more antennas 1810 and a base-station device 1820. The base-station device 1820 and each of the antennas 1810 may be connected to each other via an RF cable.

Each of the antennas 1810 includes a single or multiple antenna elements (such as multiple antenna elements included in a multiple-input multiple-output (MIMO) antenna), and is used for the base-station device 1820 to transmit and receive wireless signals. As illustrated in FIG. 16, the eNB 1800 may include multiple antennas 1810. For example, the multiple antennas 1810 may be compatible with multiple frequency bands used by the eNB 1800. Although FIG. 16 illustrates an example in which the eNB 1800 includes multiple antennas 1810, the eNB 1800 may also include a single antenna 1810.

The base-station device 1820 includes a controller 1821, a memory 1822, a network interface 1823, and a wireless communication interface 1825.

The controller 1821 may be, for example, a CPU or a DSP, and operates various functions of a higher layer of the base-station device 1820. For example, the controller 1821 generates a data packet based on data in a signal processed by the wireless communication interface 1825, and delivers the generated packet via the network interface 1823. The controller 1821 may bundle data from multiple baseband processors to generate a bundled packet, and deliver the generated bundled packet. The controller 1821 may have a logical function for performing control such as radio resource control, radio bearer control, mobility management, admission control, and scheduling. This control may be executed in conjunction with nearby eNBs or core network nodes. The memory 1822 includes RAM and ROM, and stores programs executed by the controller 1821 and various types of control data (such as a terminal list, transmission power data, and scheduling data).

The network interface 1823 is a communication interface for connecting the base-station device 1820 to a core network 1824. The controller 1821 may communicate with a core network node or another eNB via the network interface 1823. In this case, the eNB 1800 and the core network node or other eNBs may be connected to each other through a logical interface (such as an S1 interface and an X2 interface). The network interface 1823 may also be a wired communication interface, or a wireless communication interface for a wireless backhaul line. If the network interface 1823 is a wireless communication interface, the network interface 1823 may use a higher frequency band for wireless communication than the frequency band used by the wireless communication interface 1825.

The wireless communication interface 1825 supports any cellular communication scheme (such as Long Term Evolution (LTE) and LTE-Advanced), and provides wireless connection to a terminal located in a cell of the eNB 1800 via the antenna 1810. The wireless communication interface 1825 may generally include, for example, a baseband (BB) processor 1826 and an RF circuit 1827. The BB processor 1826 may perform, for example, encoding/decoding, modulation/demodulation, and multiplexing/demultiplexing, and perform various types of signal processing of layers (such as L1, medium access control (MAC), radio link control (RLC), and packet data convergence protocol (PDCP)). Instead of the controller 1821, the BB processor 1826 may have a part or all of the above-mentioned logical functions. The BB processor 1826 may be a memory storing a communication control program, or a module including a processor and related circuits configured to execute the program. The function of the BB processor 1826 may be changed by updating the program. The module may be a card or a blade inserted into a slot of the base-station device 1820. Alternatively, the module may be a chip mounted on a card or blade. Meanwhile, the RF circuit 1827 may include, for example, a mixer, a filter, and an amplifier, and transmit and receive a wireless signal via the antenna 1810.

As illustrated in FIG. 16, the wireless communication interface 1825 may include multiple BB processors 1826. For example, the multiple BB processors 1826 may be compatible with multiple frequency bands used by the eNB 1800. As illustrated in FIG. 16, the wireless communication interface 1825 may include multiple RF circuits 1827. For example, the multiple RF circuits 1827 may be compatible with multiple antenna elements. Although FIG. 16 illustrates an example in which the wireless communication interface 1825 includes multiple BB processors 1826 and multiple RF circuits 1827, the wireless communication interface 1825 may also include a single BB processor 1826 or a single RF circuit 1827.

In the eNB 1800 illustrated in FIG. 16, communication unit in the electronic device 700 or 800 of the first embodiment described above with reference to FIG. 7 or FIG. 8 and communication unit (not illustrated) of the electronic device 1100 described with reference to FIG. 11 may be implemented by the wireless communication interface 1825 and the optional antenna 1810. At least part of functions of the determination unit, the generation unit, and the aggregation unit in the electronic device 700 or 800, and the acquisition unit, the determination unit, and the generation unit in the electronic device 1100 may be implemented by the controller 1821. For example, the controller 1821 may implement functions of the above units by executing instructions stored in the memory 1822. In addition, storage units (not shown) in these electronic devices may be implemented by the memory 1822.

### Second Application Example

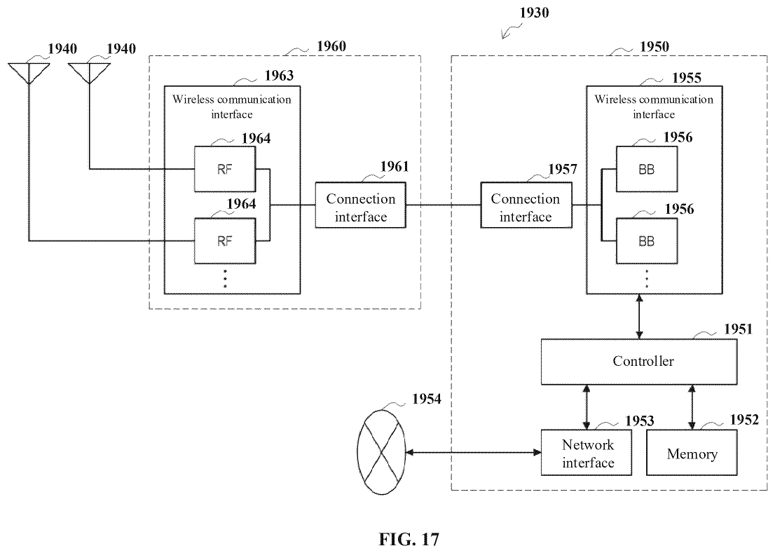

FIG. 17 is a block diagram illustrating a second example of a schematic configuration of an eNB to which the technology of the present disclosure may be applied. An eNB 1930 includes one or more antennas 1940, a base-station device 1950, and an RRH 1960. The RRH 1960 and each of the antennas 1940 may be connected to each other via an RF cable. The base-station device 1950 and the RRH 1960 may be connected to each other via a high-speed line such as an optical fiber cable.

Each of the antennas 1940 includes a single or multiple antenna elements (such as multiple antenna elements included in a MIMO antenna), and is used for the RRH 1960 to transmit and receive wireless signals. As illustrated in FIG. 17, the eNB 1930 may include multiple antennas 1940. For example, the multiple antennas 1940 may be compatible with multiple frequency bands used by the eNB 1930. Although FIG. 17 illustrates an example in which the eNB 1930 includes multiple antennas 1940, the eNB 1930 may also include a single antenna 1940.

The base-station device 1950 includes a controller 1951, a memory 1952, a network interface 1953, a wireless communication interface 1955, and a connection interface 1957. The controller 1951, the memory 1952, and the network interface 1953 are the same as the controller 1821, the memory 1822, and the network interface 1823 described with reference to FIG. 16.

The wireless communication interface 1955 supports any cellular communication scheme (such as LTE and LTE-Advanced), and provides wireless communication to a terminal located in a sector corresponding to the RRH 1960 via the RRH 1960 and the antenna 1940. The wireless communication interface 1955 may generally include, for example, a BB processor 1956. Except that the BB processor 1956 is connected to an RF circuit 1964 of the RRH 1960 via the connection interface 1957, the BB processor 1956 is the same as the BB processor 1826 described with reference to FIG. 16. As illustrated in FIG. 17, the wireless communication interface 1955 may include multiple BB processors 1956. For example, the multiple BB processors 1956 may be compatible with multiple frequency bands used by the eNB 1930. Although FIG. 17 illustrates an example in which the wireless communication interface 1955 includes multiple BB processors 1956, the wireless communication interface 1955 may also include a single BB processor 1956.

The connection interface 1957 is an interface for connecting the base-station device 1950 (the wireless communication interface 1955) to the RRH 1960. The connection interface 1957 may also be a communication module for communication in the above-mentioned high-speed line that connects the base-station device 1950 (the wireless communication interface 1955) to the RRH 1960.

The RRH 1960 includes a connection interface 1961 and a wireless communication interface 1963.

The connection interface 1961 is an interface for connecting the RRH 1960 (the wireless communication interface 1963) to the base-station device 1950. The connection interface 1961 may also be a communication module for communication in the above-mentioned high-speed line.

The wireless communication interface 1963 transmits and receives wireless signals via the antenna 1940. The wireless communication interface 1963 may generally include, for example, an RF circuit 1964. The RF circuit 1964 may include, for example, a mixer, a filter, and an amplifier, and transmit and receive wireless signals via the antenna 1940. As illustrated in FIG. 17, the wireless communication interface 1963 may include multiple RF circuits 1964. For example, the multiple RF circuits 1964 may support multiple antenna elements. Although FIG. 17 illustrates an example in which the wireless communication interface 1963 includes multiple RF circuits 1964, the wireless communication interface 1963 may also include a single RF circuit 1964.

In the eNB 1930 illustrated in FIG. 17, communication unit in the electronic device 700 or 800 described above with reference to FIG. 7 or FIG. 8 and communication unit (not illustrated) of the electronic device 1100 described with reference to FIG. 11 may be implemented, for example, by the wireless communication interface 1963 and the optional antenna 1940. At least part of functions of the determination unit, the generation unit, and the aggregation unit in the electronic device 700 or 800, and the acquisition unit, the determination unit, and the generation unit in the electronic device 1100 may be implemented by the controller 1951. For example, the controller 1951 may implement functions of the above units by executing instructions stored in the memory 1952. In addition, storage units (not shown) in these electronic devices may be implemented by the memory 1952.

### Application Examples Regarding User Equipment

### First Application Example

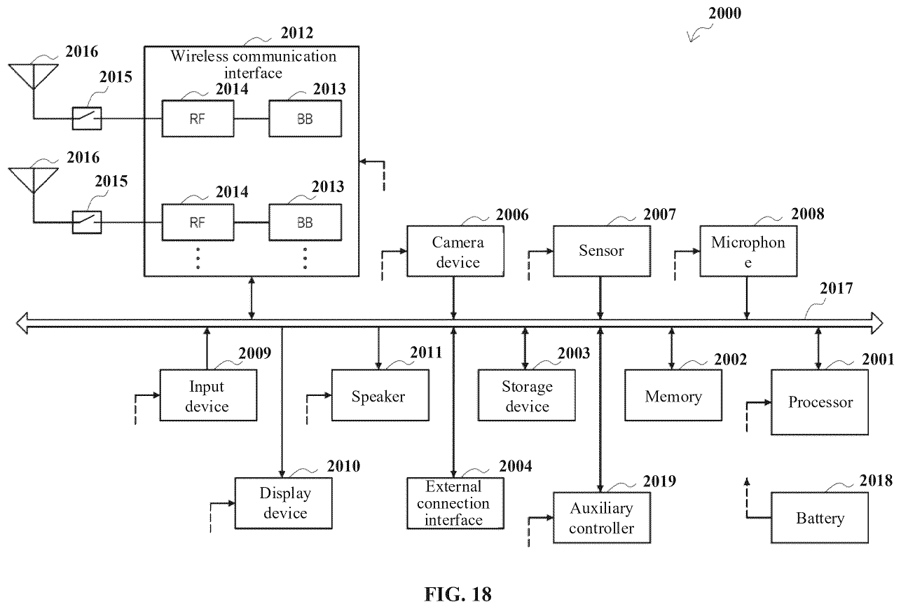

FIG. 18 is a block diagram illustrating an example of a schematic configuration of a smart phone 2000 to which the technology of the present disclosure can be applied. The smart phone 2000 includes a processor 2001, a memory 2002, a storage device 2003, an external connection interface 2004, a camera device 2006, a sensor 2007, a microphone 2008, an input device 2009, a display device 2010, a speaker 2011, a wireless communication interface 2012, one or more antenna switches 2015, one or more antennas 2016, a bus 2017, a battery 2018, and an auxiliary controller 2019.

The processor 2001 may be, for example, a CPU or a system on a chip (SoC), and controls functions of an application layer and other layers of the smart phone 2000. The memory 2002 includes RAM and ROM, and stores data and programs executed by the processor 2001. The storage device 2003 may include a storage medium, such as a semiconductor memory and a hard disk. The external connection interface 2004 is an interface for connecting an external device (such as a memory card and a universal serial bus (USB) device) to the smart phone 2000.

The camera device 2006 includes an image sensor (such as a charge coupled device (CCD) and a complementary metal oxide semiconductor (CMOS)), and generates a captured image. The sensor 2007 may include a group of sensors, such as a measurement sensor, a gyroscope sensor, a geomagnetic sensor, and an acceleration sensor. The microphone 2008 converts sound inputted to the smart phone 2000 into an audio signal. The input device 2009 includes, for example, a touch sensor, a keypad, a keyboard, a button, or a switch configured to detect a touch on a screen of the display device 2010, and receives an operation or information input from a user. The display device 2010 includes a screen (such as a liquid crystal display (LCD) and an organic light emitting diode (OLED) display), and displays an output image of the smart phone 2000. The speaker 2011 converts an audio signal outputted from the smart phone 2000 into sound.

The wireless communication interface 2012 supports any cellular communication scheme (such as LTE and LTE-Advanced), and performs wireless communication. The wireless communication interface 2012 may generally include, for example, a BB processor 2013 and an RF circuit 2014. The BB processor 2013 may perform, for example, encoding/decoding, modulation/demodulation, and multiplexing/demultiplexing, and perform various types of signal processing for wireless communication. Further, the RF circuit 2014 may include, for example, a mixer, a filter, and an amplifier, and transmit and receive wireless signals via the antenna 2016. The wireless communication interface 2012 may be a chip module on which the BB processor 2013 and the RF circuit 2014 are integrated. As illustrated in FIG. 18, the wireless communication interface 2012 may include multiple BB processors 2013 and multiple RF circuits 2014. Although FIG. 18 illustrates an example in which the wireless communication interface 2012 includes multiple BB processors 2013 and multiple RF circuits 2014, the wireless communication interface 2012 may also include a single BB processor 2013 or a single RF circuit 2014.

In addition to the cellular communication scheme, the wireless communication interface 2012 may support another type of wireless communication scheme, such as a short-range wireless communication scheme, a near field communication scheme, and a wireless local area network (LAN) scheme. In this case, the wireless communication interface 2012 may include a BB processor 2013 and an RF circuit 2014 for each wireless communication scheme.

Each of the antenna switches 2015 switches a connection destination of the antenna 916 among multiple circuits included in the wireless communication interface 2012 (for example, circuits for different wireless communication schemes).

Each of the antennas 2016 includes a single or multiple antenna elements (such as multiple antenna elements included in a MIMO antenna), and is used for the wireless communication interface 2012 to transmit and receive wireless signals. As illustrated in FIG. 18, the smart phone 2000 may include multiple antennas 2016. Although FIG. 18 illustrates an example in which the smart phone 2000 includes multiple antennas 2016, the smart phone 2000 may also include a single antenna 2016.

In addition, the smart phone 2000 may include an antenna 2016 for each wireless communication scheme. In this case, the antenna switch 2015 may be omitted from the configuration of the smart phone 2000.

The bus 2017 connects the processor 2001, the memory 2002, the storage device 2003, the external connection interface 2004, the camera device 2006, the sensor 2007, the microphone 2008, the input device 2009, the display device 2010, the speaker 2011, the wireless communication interface 2012, and the auxiliary controller 2019 to each other. The battery 2018 supplies power to each block of the smart phone 2000 illustrated in FIG. 18 via a feeder line, and the feeder line is partially illustrated as a dashed line in the figure. The auxiliary controller 2019, for example, operates the least necessary function of the smart phone 2000 in the sleep mode.

In the smart phone 2000 illustrated in FIG. 18, communication unit in the electronic device 300 described above with reference to FIG. 3, communication unit in the electronic device 700 or 800 described with reference to FIG. 7 or FIG. 8, and communication unit (not illustrated) of the electronic device 1100 described with reference to FIG. 11 may be implemented by the wireless communication interface 2012 and the optional antenna 2016. At least part of functions of the acquisition unit and the generation unit in the electronic device 300, the determination unit, the generation unit, and the aggregation unit in the electronic device 700 or 800, and the acquisition unit, the determination unit, and the generation unit in the electronic device 1100 may be implemented by the processor 2001 or the auxiliary controller 2019. For example, the processor 2001 or the auxiliary controller 2019 may implement functions of the above units by executing instructions stored in the memory 2002 or the storage device 2003. In addition, storage units (not shown) in these electronic devices may be implemented by the memory 2002 or the storage device 2003.

### Second Application Example

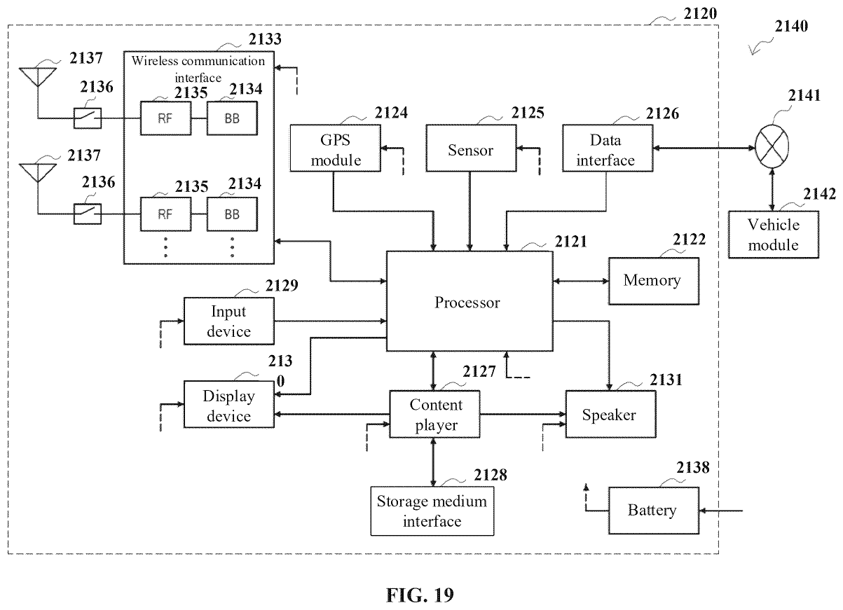

FIG. 19 is a block diagram illustrating an example of a schematic configuration of a vehicle navigation device 2120 to which the technology of the present disclosure may be applied. The vehicle navigation device 2120 includes a processor 2121, a memory 2122, a global positioning system (GPS) module 2124, a sensor 2125, a data interface 2126, a content player 2127, a storage medium interface 2128, an input device 2129, a display device 2130, a speaker 2131, a wireless communication interface 2133, one or more antenna switches 2136, one or more antennas 2137, and a battery 2138.

The processor 2121 may be, for example, a CPU or a SoC, and controls a navigation function of the vehicle navigation device 2120 and other functions. The memory 2122 includes RAM and ROM, and stores data and programs executed by the processor 2121.

The GPS module 2124 measures a position (such as a latitude, a longitude, and a altitude) of the vehicle navigation device 2120 based on a GPS signal received from a GPS satellite. The sensor 2125 may include a group of sensors, such as a gyroscope sensor, a geomagnetic sensor, and an air pressure sensor. The data interface 2126 is connected to, for example, an in-vehicle network 2141 via a terminal (not illustrated), and acquires data (such as vehicle speed data) generated by the vehicle.

The content player 2127 reproduces content stored in a storage medium (such as a CD and a DVD), which is inserted into the storage medium interface 2128. The input device 2129 includes, for example, a touch sensor, a button, or a switch configured to detect a touch on a screen of the display device 2130, and receives an operation or information input from the user. The display device 2130 includes a screen such as an LCD or OLED display, and displays an image of a navigation function or reproduced content. The speaker 2131 outputs the sound of the navigation function or the reproduced content.

The wireless communication interface 2133 supports any cellular communication scheme (such as LTE and LTE-Advanced), and performs wireless communication. The wireless communication interface 2133 may generally include, for example, a BB processor 2134 and an RF circuit 2135. The BB processor 2134 may perform, for example, encoding/decoding, modulation/demodulation, and multiplexing/demultiplexing, and perform various types of signal processing for wireless communication. Further, the RF circuit 2135 may include, for example, a mixer, a filter, and an amplifier, and transmit and receive wireless signals via the antenna 2137. The wireless communication interface 2133 may also be a chip module on which the BB processor 2134 and the RF circuit 2135 are integrated. As illustrated in FIG. 19, the wireless communication interface 2133 may include multiple BB processors 2134 and multiple RF circuits 2135. Although FIG. 19 illustrates an example in which the wireless communication interface 2133 includes multiple BB processors 2134 and multiple RF circuits 2135, the wireless communication interface 2133 may also include a single BB processor 2134 or a single RF circuit 2135.

In addition to the cellular communication scheme, the wireless communication interface 2133 may support another type of wireless communication scheme, such as a short-range wireless communication scheme, a near field communication scheme, and a wireless LAN scheme. In this case, the wireless communication interface 2133 may include a BB processor 2134 and an RF circuit 2135 for each wireless communication scheme.

Each of the antenna switches 2136 switches a connection destination of the antenna 2137 among multiple circuits included in the wireless communication interface 2133 (such as circuits for different wireless communication schemes).

Each of the antennas 2137 includes a single or multiple antenna elements (such as multiple antenna elements included in a MIMO antenna), and is used for the wireless communication interface 2133 to transmit and receive wireless signals. As illustrated in FIG. 19, the vehicle navigation device 2120 may include multiple antennas 2137. Although FIG. 19 illustrates an example in which the vehicle navigation device 2120 includes multiple antennas 2137, the vehicle navigation device 2120 may also include a single antenna 2137.

In addition, the vehicle navigation device 2120 may include an antenna 2137 for each wireless communication scheme. In this case, the antenna switch 2136 may be omitted from the configuration of the vehicle navigation device 2120.

The battery 2138 supplies power to each block of the vehicle navigation device 2120 illustrated in FIG. 19 via a feeder line, and the feeder line is partially illustrated as a dashed line in the figure. The battery 2138 accumulates electric power supplied from the vehicle.

In the vehicle navigation device 2120 illustrated in FIG. 19, communication unit in the electronic device 300 described above with reference to FIG. 3, communication unit in the electronic device 700 or 800 described with reference to FIG. 7 or FIG. 8, and communication unit (not illustrated) of the electronic device 1100 described with reference to FIG. 11 may be implemented by the wireless communication interface 2133 and the optional antenna 2137. At least part of functions of the acquisition unit and the generation unit in the electronic device 300, the determination unit, the generation unit, and the aggregation unit in the electronic device 700 or 800, and the acquisition unit, the determination unit, and the generation unit in the electronic device 1100 may be implemented by the processor 2121. For example, the processor 2121 may implement functions of the above units by executing instructions stored in the memory 2122. In addition, storage units (not shown) in these electronic devices may be implemented by the memory 2122.

The technology of the present disclosure may also be implemented as an in-vehicle system (or vehicle) 2140 including one or more blocks in the vehicle navigation device 2120, the in-vehicle network 2141, and a vehicle module 2142. The vehicle module 2142 generates vehicle data (such as vehicle speed, engine speed, and failure information), and outputs the generated data to the in-vehicle network 2141.

The preferred embodiments of the present disclosure have been described above with reference to the drawings. However, the present disclosure is of course not limited to the above examples. Those skilled in the art may obtain various changes and modifications within the scope of the appended claims, and it should be understood that these changes and modifications naturally fall within the technical scope of the present disclosure.

For example, units illustrated in dashed boxes in the functional block diagrams shown in the drawings each indicate that the functional unit is optional in a corresponding device, and respective optional functional units may be combined in an appropriate way to implement required functions.

For example, multiple functions included in one unit in the above embodiments may be implemented by separate devices. Alternatively, multiple functions implemented by multiple units in the above embodiments may be implemented by separate devices, respectively. In addition, one of the above functions may be implemented by multiple units. Needless to say, such a configuration is included in the technical scope of the present disclosure.

In this specification, steps described in the flowchart include processing performed in the chronological order described herein, and also include processing performed in parallel or independently rather than necessarily in the chronological order. In addition, even in steps processed in the chronological order, needless to say, the order may also be appropriately changed.

In addition, the present disclosure may have the following configurations.
1. An electronic device, comprising:

A processing circuit, configured to:
obtain an index of a quality of a cooperative transmission implemented by a current cooperating device, the cooperating device relaying a part of data originating from a source device and to be transmitted to a destination device to implement the cooperative transmission;
generate, depending on a relationship between the index and first to third ranges which sequentially indicate qualities of transmission from high to low, a status report about the current cooperating device; and
transmit the generated status report to another electronic device.
2. The electronic device according to configuration 1, wherein the index indicates one or more of: a distance between the cooperating device and the source device; a quality of a signal received by the cooperating device from the source device; or a quality of a signal received by the destination device through the cooperative transmission.
3. The electronic device according to configuration 2, wherein the index indicating the quality of the signal received by the destination device through the cooperative transmission is determined based on one or more of: a probability of packet retransmission between the source device and the cooperating device; a probability of packet retransmission between the cooperating device and the destination device; and a transmission delay between the cooperating device and the destination device.
4. The electronic device according to configuration 1, wherein the first range, the second range, and the third range are divided based on a first threshold and a second threshold of the index determined based on the following thresholds:
a first threshold and a second threshold of a transmission rate between the cooperating device and the source device;
a first threshold and a second threshold of a quality of a signal received by the cooperating device from the source device;
a first threshold and a second threshold of a number of retransmissions between the cooperating device and the source device; and/or
a first threshold and a second threshold of a quality of a signal received by the destination device through the cooperative transmission.
5. The electronic device according to configuration 1, wherein the electronic device is used for the source device or the cooperating device, and the processing circuit is further configured to:
in a case where the index falls within the first range indicating highest quality of transmission, generate no status report;
in a case where the index falls within the second range indicating medium quality of transmission, generate a first status report; and/or
in a case where the index falls within the third range indicating lowest quality of transmission, terminate communication between the cooperating device and the source device, and generate a second status report.
6. The electronic device according to configuration 5, wherein the processing circuit is further configured to:
receive an adjustment notification generated by said another electronic device based on the received status report, the adjustment notification instructing an adjustment to the cooperative transmission.
7. The electronic device according to configuration 6, wherein the processing circuit is further configured to:
perform the adjusted cooperative transmission according to an instruction of the adjustment notification.
8. The electronic device according to configuration 6, wherein the processing circuit is further configured to:
receive a first adjustment notification generated by said another electronic device based on the first status report, the notification instructing an adjustment to communication resources allocated for a current sidelink communication between the current cooperating device and the source device.
9. The electronic device according to configuration 8, wherein the first adjustment notification instructs an allocation of increased feedback resources for the current sidelink communication to the current cooperating device, or instructs an allocation of frequency resources in a second frequency band lower than a first frequency band currently in use to the current sidelink communication.
10. The electronic device according to configuration 6, wherein the processing circuit is further configured to:
receive a second adjustment notification generated by said another electronic device based on the second status report, the notification instructing the current cooperating device to exit the cooperative transmission.
11. An electronic device, comprising:
a processing circuit, configured to:
receive a status report about a current cooperating device, the cooperating device relaying a part of data originating from a source device and to be transmitted to a destination device to implement a cooperative transmission; and
determine, based on the received status report, an adjustment to the cooperative transmission,
wherein the status report is generated depending on a relationship between an index of a quality of the cooperative transmission implemented by the current cooperating device and first to third ranges which sequentially indicate qualities of transmission from high to low.
12. The electronic device according to configuration 11, wherein the processing circuit is further configured to:
generate an adjustment notification instructing an adjustment to the cooperative transmission, and transmit the generated adjustment notification to the cooperating device and/or the source device.
13. The electronic device according to configuration 12, wherein the processing circuit is further configured to:
receive a first status report generated in a case where the index falls within the second range indicating medium quality of transmission; and/or
receive a second status report generated in a case where the index falls within the third range indicating lowest quality of transmission.
14. The electronic device according to configuration 13, wherein the processing circuit is further configured to:
determine, based on the first or second status report, to increase a transmission amount and/or a transmission rate of one or more other cooperating devices in the cooperative transmission, and/or to add a new cooperating device to the cooperative transmission.
15. The electronic device according to configuration 13, wherein the processing circuit is further configured to:
determine, based on the first status report, to adjust resources allocated for a current sidelink communication between a current cooperating device and a source device.
16. The electronic device according to configuration 15, wherein the processing circuit is further configured to:
increase feedback resources allocated to the current cooperating device for the current sidelink communication; and/or
switch frequency resources allocated for the current sidelink communication from a first frequency band to a second frequency band lower than the first frequency band.
17. The electronic device according to configuration 13, wherein the processing circuit is further configured to:
determine, based on the second status report, to cause the current cooperating device to exit the cooperative transmission.
18. The electronic device according to configuration 11, wherein the processing circuit is further configured to:
receive the status report from the cooperating device or the source device.
19. The electronic device according to configuration 11, wherein the electronic device is used for the destination device.
20. The electronic device according to configuration 19, wherein the processing circuit is further configured to:
receive, from the current cooperating device, a part of data originating from the source device and to be transmitted to the destination device;
receive, from at least one of other devices, other parts of data originating from the source device and to be transmitted to the destination device; and
integrate the received parts of data originating from the source device.
21. An electronic device, comprising:
a processing circuit, configured to:
obtain an index of a quality of a cooperative transmission implemented by a current cooperating device, the cooperating device relaying a part of data originating from a source device and to be transmitted to a destination device to implement the cooperative transmission;
determine, depending on a relationship between the index and first to third ranges which sequentially indicate qualities of transmission from high to low, an adjustment to the cooperative transmission.
22. A communication method, comprising:
obtaining an index of a quality of a cooperative transmission implemented by a current cooperating device, the cooperating device relaying a part of data originating from a source device and to be transmitted to a destination device to implement the cooperative transmission;
generating, depending on a relationship between the index and a first to third ranges which sequentially indicate qualities of transmission from high to low, a status report about the current cooperating device; and
transmitting the generated status report to another electronic device.
23. A communication method, comprising:
receiving a status report about a current cooperating device, the cooperating device relaying a part of data originating from a source device and to be transmitted to a destination device to implement a cooperative transmission; and
determining, based on the received status report, an adjustment to the cooperative transmission,
wherein the status report is generated depending on a relationship between an index of a quality of the cooperative transmission implemented by the current cooperating device and first to third ranges which sequentially indicate qualities of transmission from high to low.
24. A communication method, comprising:
obtaining an index of a quality of a cooperative transmission implemented by a current cooperating device, the cooperating device relaying a part of data originating from a source device and to be transmitted to a destination device to implement the cooperative transmission;
determining, depending on a relationship between the index and a first to third ranges which sequentially indicate qualities of transmission from high to low, an adjustment to the cooperative transmission.
25. A non-transitory computer-readable storage medium having executable instructions stored thereon, wherein the executable instructions, when executed by a processor, cause the processor to perform the wireless communication method according to any one of configurations 22 to 24.

Although the embodiments of the present disclosure have been described above in detail with reference to the drawings, it should be understood that the above-described embodiments are merely for illustrating the present disclosure and do not constitute a limitation to the present disclosure. Various modifications and changes may be made to the above embodiments by those skilled in the art without departing from the spirit and scope of the present disclosure. Therefore, the scope of the present disclosure is limited only by the appended claims and equivalents thereof.

1. An electronic device, comprising:
a processing circuit, configured to:
obtain an index of a quality of a cooperative transmission implemented by a current cooperating device, the cooperating device relaying a part of data originating from a source device and to be transmitted to a destination device to implement the cooperative transmission;
generate, depending on a relationship between the index and first to third ranges which sequentially indicate qualities of transmission from high to low, a status report about the current cooperating device; and
transmit the generated status report to another electronic device.

2. The electronic device according to claim 1, wherein the index indicates one or more of: a distance between the cooperating device and the source device; a quality of a signal received by the cooperating device from the source device; or a quality of a signal received by the destination device through the cooperative transmission.

3. The electronic device according to claim 2, wherein the index indicating the quality of the signal received by the destination device through the cooperative transmission is determined based on one or more of: a probability of packet retransmission between the source device and the cooperating device; a probability of packet retransmission between the cooperating device and the destination device; and a transmission delay between the cooperating device and the destination device.

4. The electronic device according to claim 1, wherein the first range, the second range, and the third range are divided based on a first threshold and a second threshold of the index determined based on the following thresholds:
a first threshold and a second threshold of a transmission rate between the cooperating device and the source device;
a first threshold and a second threshold of a quality of a signal received by the cooperating device from the source device;
a first threshold and a second threshold of a number of retransmissions between the cooperating device and the source device; and/or
a first threshold and a second threshold of a quality of a signal received by the destination device through the cooperative transmission.

5. The electronic device according to claim 1, wherein the electronic device is used for the source device or the cooperating device, and the processing circuit is further configured to:
in a case where the index falls within the first range indicating the highest quality of transmission, generate no status report;
in a case where the index falls within the second range indicating medium quality of transmission, generate a first status report; and/or
in a case where the index falls within the third range indicating the lowest quality of transmission, terminate communication between the cooperating device and the source device, and generate a second status report.

6. The electronic device according to claim 5, wherein the processing circuit is further configured to:
receive an adjustment notification generated by said another electronic device based on the received status report, the adjustment notification instructing an adjustment to the cooperative transmission.

7. The electronic device according to claim 6, wherein the processing circuit is further configured to:
perform the adjusted cooperative transmission according to an instruction of the adjustment notification.

8. The electronic device according to claim 6, wherein the processing circuit is further configured to:
receive a first adjustment notification generated by said another electronic device based on the first status report, the notification instructing an adjustment to communication resources allocated for a current sidelink communication between the current cooperating device and the source device.

9. The electronic device according to claim 8, wherein the first adjustment notification instructs an allocation of increased feedback resources for the current sidelink communication to the current cooperating device, or instructs an allocation of frequency resources in a second frequency band lower than a first frequency band currently in use to the current sidelink communication.

10. The electronic device according to claim 6, wherein the processing circuit is further configured to:
receive a second adjustment notification generated by said another electronic device based on the second status report, the notification instructing the current cooperating device to exit the cooperative transmission.

11. An electronic device, comprising:
a processing circuit, configured to:
receive a status report about a current cooperating device, the cooperating device relaying a part of data originating from a source device and to be transmitted to a destination device to implement a cooperative transmission; and
determine, based on the received status report, an adjustment to the cooperative transmission,
wherein the status report is generated depending on a relationship between an index of a quality of the cooperative transmission implemented by the current cooperating device and first to third ranges which sequentially indicate qualities of transmission from high to low.

12. The electronic device according to claim 11, wherein the processing circuit is further configured to:
generate an adjustment notification instructing an adjustment to the cooperative transmission, and transmit the generated adjustment notification to the cooperating device and/or the source device.

13. The electronic device according to claim 12, wherein the processing circuit is further configured to:
receive a first status report generated in a case where the index falls within the second range indicating medium quality of transmission; and/or
receive a second status report generated in a case where the index falls within the third range indicating lowest quality of transmission.

14. The electronic device according to claim 13, wherein the processing circuit is further configured to:
determine, based on the first or second status report, to increase a transmission amount and/or a transmission rate of one or more other cooperating devices in the cooperative transmission, and/or to add a new cooperating device to the cooperative transmission.

15. The electronic device according to claim 13, wherein the processing circuit is further configured to:
determine, based on the first status report, to adjust resources allocated for a current sidelink communication between a current cooperating device and a source device; or
determine, based on the second status report, to cause the current cooperating device to exit the cooperative transmission.

16. The electronic device according to claim 15, wherein the processing circuit is further configured to, in a case of determining to adjust resources allocated for the current sidelink communication,
increase feedback resources allocated to the current cooperating device for the current sidelink communication; and/or
switch frequency resources allocated for the current sidelink communication from a first frequency band to a second frequency band lower than the first frequency band.

17. (canceled)

18. The electronic device according to claim 11, wherein the processing circuit is further configured to:
receive the status report from the cooperating device or the source device.

19. The electronic device according to claim 11, wherein the electronic device is used for the destination device.

20. The electronic device according to claim 19, wherein the processing circuit is further configured to:
receive, from the current cooperating device, a part of data originating from the source device and to be transmitted to the destination device;
receive, from at least one of other devices, other parts of data originating from the source device and to be transmitted to the destination device; and
integrate the received parts of data originating from the source device.

21. An electronic device, comprising:
a processing circuit, configured to:
obtain an index of a quality of a cooperative transmission implemented by a current cooperating device, the cooperating device relaying a part of data originating from a source device and to be transmitted to a destination device to implement the cooperative transmission;
determine, depending on a relationship between the index and first to third ranges which sequentially indicate qualities of transmission from high to low, an adjustment to the cooperative transmission.

22.-25. (canceled)
